(19) United States
(12) Patent Application Publication
(10) Pub. No.: US 2026/0037129 A1
(43) Pub. Date: Feb. 5, 2026

(54) STORAGE DEVICE SUPPORTING SPECULATIVE READ OPERATION

(71) Applicant: SK hynix Inc., Gyeonggi-do (KR)

(72) Inventors: Du Hyun KIM, Gyeonggi-do (KR); Dong Hun JEONG, Gyeonggi-do (KR)

(21) Appl. No.: 18/977,949

(22) Filed: Dec. 12, 2024

(30) Foreign Application Priority Data
Jul. 31, 2024 (KR) 10-2024-0101721

(51) Int. Cl. G06F 3/06

(52) U.S. Cl. CPC G06F 3/0611; G06F 3/0656; G06F 3/0673

(57) ABSTRACT

A memory system receives data output from at least one memory device based on a speculative read request input from a host, stores the received data in a read buffer based on information about a residual time input along with the speculative read request, and outputs first data among the data stored in the read buffer to the host. The first data is stored in the read buffer based on the speculative read request and linked to a read request input from the host after the speculative read request.

### CROSS-REFERENCE TO RELATED APPLICATIONS

This patent application claims the benefit of priority under 35 U.S.C. § 119(a) to Korean Patent Application No. 10-2024-0101721, filed on Jul. 31, 2024, the entire disclosure of which is incorporated herein by reference.

### TECHNICAL FIELD

One or more embodiments of the present disclosure described herein relates to a memory system (e.g., CXL™ device), and more particularly, to the memory system which supports a speculative read operation and includes a memory expansion device or a shared memory device connected to at least one host.

### BACKGROUND

In computing systems, their computational volume increases in response to a user's needs. Due to the increase in computational volume, the amount of data generated or stored is also increasing. While the amount of data is increasing, a storage area for storing data in a computing system is limited. A memory expansion device or a shared memory device can be used to store a significant amount of data and avoid degradation of the computing system's computational ability and performance. The memory expansion device can be understood as a composable infrastructure for overcoming limitations of the computing system's resources. When performing high-speed data communication, a computing system and a memory expansion device can support the computation of high-density workloads such as big data and machine learning. A memory system can transmit a response to a request with a limited operation time during data communication with a host within a preset time.

### BRIEF DESCRIPTION OF THE DRAWINGS

The description herein makes reference to the accompanying drawings wherein like reference numerals refer to like parts throughout the figures.

FIG. 1 illustrates a data processing apparatus according to an embodiment of the present disclosure.

FIG. 2 illustrates an operation of a memory system according to an embodiment of the present disclosure.

FIG. 3 illustrates a configuration of a controller according to an embodiment of the present disclosure.

FIG. 4 illustrates a hazard control scheme regarding data input/output operations according to an embodiment of the present disclosure.

FIG. 5 illustrates a first operation for hazard avoidance in a memory system according to an embodiment of the present disclosure.

FIG. 6 illustrates a second operation for hazard avoidance in a memory system according to an embodiment of the present disclosure.

FIG. 7 illustrates a third operation for hazard avoidance in a memory system according to an embodiment of the present disclosure.

FIG. 8 illustrates a fourth operation for hazard avoidance in a memory system according to an embodiment of the present disclosure.

FIG. 9 illustrates a first operation of a read buffer in a memory system according to an embodiment of the present disclosure.

FIG. 10 illustrates a second operation of a read buffer in a memory system according to an embodiment of the present disclosure.

FIG. 11 illustrates a first operation for generating a response in a memory system according to an embodiment of the present disclosure.

FIG. 12 illustrates a second operation for generating a response in a memory system according to an embodiment of the present disclosure.

FIG. 13 illustrates a third operation for generating a response in a memory system according to an embodiment of the present disclosure.

FIG. 14 illustrates a fourth operation for generating a response in a memory system according to an embodiment of the present disclosure.

FIG. 15 illustrates a data infrastructure according to an embodiment of the present disclosure.

FIG. 16 illustrates a computer-memory link-based switch according to an embodiment of the present disclosure.

### DETAILED DESCRIPTION

Various embodiments of the present disclosure are described below with reference to the accompanying drawings. Elements and features of this disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. Examples of block/unit/circuit/component used with the “configured to” language include hardware, circuits, memory storing program instructions executable to implement the operation, etc. Additionally, “configured to” can include a generic structure, e.g., generic circuitry, that is manipulated by software and/or firmware, e.g., an FPGA or a general-purpose processor executing software to operate in a manner that is capable of performing the task(s) at issue. “Configured to” may also include adapting a manufacturing process, e.g., a semiconductor fabrication facility, to fabricate devices, e.g., integrated circuits that are adapted to implement or perform one or more tasks.

As used in this disclosure, the term ‘machine,’ ‘circuitry’ or ‘logic’ refers to all of the following: (a) hardware-only circuit implementations such as implementations in only analog and/or digital circuitry and (b) combinations of circuits and software and/or firmware, such as (as applicable): (i) to a combination of processor(s) or (ii) to portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘machine,’ ‘circuitry’ or ‘logic’ applies to all uses of this term in this application, including in any claims. As a further example, as used in this application, the term ‘machine,’ ‘circuitry’ or ‘logic’ also covers an implementation of merely a processor or multiple processors or a portion of a processor and its (or their) accompanying software and/or firmware. The term ‘machine,’ ‘circuitry’ or ‘logic’ also covers, for example, and if applicable to a particular claim element, an integrated circuit for a storage device.

As used herein, the terms ‘first,’ ‘second,’ ‘third,’ and so on are used as labels for nouns that they precede, and do not imply any type of ordering, e.g., spatial, temporal, logical, etc. The terms ‘first’ and ‘second’ do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term ‘based on’ is used to describe one or more factors that affect a determination. This term does not foreclose additional factors that may affect determination. The determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

An embodiment of the present disclosure can provide a device and method capable of improving the performance of a computing system including a host and a memory sharing device or a memory expansion device.

Another embodiment of the present disclosure can provide a device capable of reducing a host's latency time of accessing data within a memory system.

In accordance with an embodiment of the present disclosure, a memory system is coupled to at least one memory device, and comprises a processor and a memory coupled to the processor, the memory storing program instructions that, when executed by the processor, cause the processor to receive data output from the memory device based on a speculative read request input from a host; store the received data in a read buffer based on information about a residual time input along with the speculative read request; and output first data among the data stored in the read buffer to the host, the first data which is stored in the read buffer based on the speculative read request and linked to a read request input from the host after the speculative read request.

The read buffer can be configured to temporarily store data which is read and output from the at least one memory device based on the speculative read request and the read request.

The read buffer can be configured to store second data, read from the memory device based on the speculative read request but not linked to the read request input from the host, release the second data based on the residual time after stored in the read buffer, and store third data which is read from the memory device based on the read request and input to and output from the read buffer by a first in first out (FIFO) way.

The memory system can further include a hazard control unit configured to perform a control hazard operation that transmits or schedules a read command to the memory device based on the speculative read request or the read request, and perform a data hazard operation that receives at least one data corresponding to the read command from the memory device and manages the at least one data to be output to the host.

The hazard control unit can include a flow controller configured to determine a processing order of the speculative read request and the read request; a decoder configured to identify a target of the speculative read request or the read request; the read buffer configured to temporarily store the at least one data which is read and output from the memory device based on the speculative read request or the read request; an arbiter configured to transmit a control signal corresponding to the speculative read request or the read request to the memory device; and a response generator configured to generate a response corresponding to the read request based on the at least one data stored in the read buffer.

The hazard control unit can further include a read pointer controller configured to verify whether a target of the read request transmitted from the flow controller is stored in the read buffer by the speculative read request before a read operation corresponding to the read request.

The decoder can be configured to, based on a verification result of the read pointer controller, perform one of transferring the read request to the arbiter; and notifying the response generator whether the target of the read request exists in the read buffer.

The at least one data stored in the read buffer can include at least one of second data which is read from the memory device based on the speculative read request but not linked to the read request input from the host, release the second data based on the residual time after stored in the read buffer; and store third data which is read from the memory device based on the read request and released when the response corresponding to the read request is generated.

The information about the residual time can include at least one of a first value indicating the residual time; and a second value indicating an increase or decrease from a reference value which is set by the host.

In another embodiment, a memory system can include at least one processor; and at least one memory device coupled to the processor via a data path. The processor can be configured to transfer a speculative read request to the memory device; receive data output from the memory device based on the speculative read request; store the received data in a read buffer based on information about a residual time input along with the speculative read request; and output first data among the data stored in the read buffer to the host, the first data which is stored based on the speculative read request and linked to a read request input from a host.

The speculative read request can include at least one of a first value indicating the residual time; and a second value indicating an increase or decrease from a reference value which is set by the host.

The read buffer can be configured to temporarily store data which is read and output from the at least one memory device based on the speculative read request and the read request.

The read buffer can be configured to store second data, read from the memory device based on the speculative read request but not linked to the read request input from the host which is released based on the residual time after being stored in the read buffer, and third data which is read from the memory device based on the read request and input to and output from the read buffer by a first in first out (FIFO) way.

The memory system can include a hazard control unit configured to perform a control hazard operation that transmits or schedules a read command to the memory device based on the speculative read request or the read request, and perform a data hazard operation that receives at least one data corresponding to the read command from the memory device and manages the at least one data to be output to the host.

The hazard control unit can include a flow controller configured to determine a processing order of the speculative read request and the read request; a decoder configured to identify a target of the speculative read request or the read request; the read buffer configured to temporarily store the at least one data which is read and output from the memory device based on the speculative read request or the read request; an arbiter configured to transmit a control signal corresponding to the speculative read request or the read request to the memory device; and a response generator configured to generate a response corresponding to the read request based on the at least one data stored in the read buffer.

The hazard control unit can further include a read pointer controller configured to verify whether a target of the read request transmitted from the flow controller is stored in the read buffer by the speculative read request before a read operation corresponding to the read request.

The decoder can be configured to, based on a verification result of the read pointer controller, perform one of transferring the read request to the arbiter; and notifying the response generator whether the target of the read request exists in the read buffer.

The at least one data stored in the read buffer can include at least one of: second data which is read from the memory device based on the speculative read request but not linked to the read request input from the host, and released based on the residual time after stored in the read buffer; and third data which is read from the memory device based on the read request and released when the response corresponding to the read request is generated.

In another embodiment, a data processing apparatus, can include at least one host configured to transmit a speculative read request along with information about a residual time through a computer-memory link-based protocol or interface and transmit a read request after transmitting the speculative read request; and a memory system configured to store first data corresponding to the speculative read request in a read buffer during the residual time, find second data corresponding to the read request among the first data stored in the read buffer, and output the second data to the host.

The memory system can be configured to, when the second data is stored in the read buffer after a read operation performed by the memory device in response to the read request, generate a response including the second data and then removes the second data from the read buffer. The first data corresponding to the speculative read request is removed from the read buffer based on the residual time.

These and other features and advantages of the disclosure will become apparent from the detailed description and the accompanying drawings of embodiments of the present disclosure. Embodiments will now be described with reference to the accompanying drawings, wherein like numbers reference like elements.

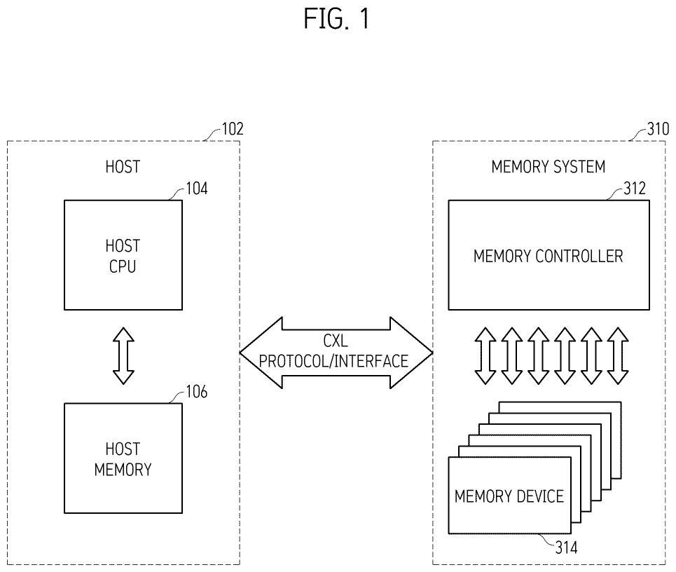

FIG. 1 illustrates a data processing apparatus according to an embodiment of the present disclosure.

Referring to FIG. 1, the data processing device may include a host 102 and a memory system (e.g., compute express link (CXL™) device) 310. The host 102 and the memory system 310 can perform data communication via a computer-memory link-based (e.g., CXL™) protocol or interface.

The memory system 310 can be designed to support memory-centric computing technology. The memory-centric computing technology can provide a dynamically scalable shared memory that overcomes the limitations of large-capacity data processing performance and capacity occurring in one type of CPU-centric systems that have been proposed, in line with demands or requirements for a memory disaggregation system. Thus, the system scale can be flexibly maintained in line with requirements regarding the data processing apparatus. Due to the explosive increase in amounts of data from emerging applications such as big data and artificial intelligence (AI), the data processing apparatus including at least one computing device can be designed or built to satisfy large-capacity, high-bandwidth memory, or innovative architectural changes. The number of servers and memory devices can continue to increase to meet overwhelming memory requirements. The computer-memory link-based protocol or computer-memory link-based interface can be provided to support large-capacity and high-bandwidth memory.

Memory disaggregation can be an architectural solution that separates a memory (e.g., a memory device) from a compute node (e.g., a computing device), allowing a system designer to flexibly expand additional memory capacity independently of each computing server while meeting the memory requirements of user applications. For example, a computing server with high memory usage can use a memory device located farther away from other nodes included in a disaggregated group. Accordingly, this disaggregation scheme can manage or use resources more efficiently than one type of dedicated CPU and memory architectures that have been proposed. The computer-memory link (e.g., Compute Express Link, CXL™) can be provided to accelerate architectural transition to memory disaggregation. The computer-memory link is an industry-supported cache-coherent interconnect (CCI) for various processors to efficiently expand memory capacity through a memory semantic protocol. Unlike a host memory 106 that is entirely dependent on a host central processing unit (CPU) 104, a memory device 314 connected via the CXL protocol or CXL interface to the host 102 can include additional data or values such as data processing engines through handshaking communication, as a memory.

The host 102 can include the host central processing unit (CPU) 104 and the host memory 106. The number and configuration of the host central processing units (CPU) 104 and the host memory 106 can vary depending on the performance, operating requirements, operating speed, and data input/output speed of the host 102. The host central processing unit (CPU) 104 and the host memory 106 can transmit and receive data through a communication interface protocol mutually agreed upon with each other. There are various communication standards or interfaces such as Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe), Serial-attached SCSI (SAS), Serial Advanced Technology Attachment (SATA), and Mobile Industry Processor Interface (MIPI), as examples of agreed upon standards for transmitting and receiving data. According to an embodiment, the host 102 and the host memory 106 can be coupled via a Universal Serial Bus (USB). The Universal Serial Bus (USB) can include an expandable, hot-pluggable plug-and-play serial interface that ensures an economical standard connection to peripheral devices such as a keyboard, mouse, joystick, printer, scanner, storage device, modem, video conferencing camera, etc.

In FIG. 1, the host 102 can perform data communication with the memory system 310 through the computer-memory link-based protocol or interface (e.g., CXL™ protocol or CXL™ interface). CXL™ (Compute Express Link) and PCIe (Peripheral Component Interconnect Express) are both standard interfaces for connecting peripherals and CPUs in a computer system. However, there are differences in several aspects between the CXL™ and the PCIe. First, the PCIe is designed as a standard for general input/output devices, while the CXL™ is an interface specialized for memory access and high-speed data transmission in a high-performance computing environment. Thus, the CXL™ is designed so that the CPU can directly access the memory of the device, while the PCIe may have limited such functions. In addition, while the PCIe uses a unidirectional communication way, the CXL™ can support bidirectional communication. For example, the CXL™ devices can support to send and receive data simultaneously. Because the CXL™ is designed to maintain backward compatibility with the PCIe, the CXL™ device could be designed or implemented by utilizing one type of PCIe infrastructure that has been proposed.

According to an embodiment, data communication of the memory device 314 (e.g., a CXL™ memory device) distributed to the host central processing unit (CPU) 104 may have a limited interface bandwidth, as compared to that of the host memory 106. For example, in cases of DDR4 DIMM and DDR5 DIMM used as the host memory 106, the DIMM has 64-bit (i.e., 8-byte) data width. The maximum bandwidth could be 2.56 GB/s (=3.2 Gbps×8 bytes) for DDR4 and 38.4 GB/s (=4.8 Gbps×8 bytes) or 51.2 GB/s (=6.4 Gbps×8 bytes) for DDR5. Accordingly, the interface bandwidth may be 0.4 s⁻¹ (=25.6 GB/s/64 GB) and 0.6^{s-1} (=38.4 GB/s/64 GB) or 0.8^{s-1} (=51.2 GB/s/64 GB) when a storage capacity of each chip is 64 Gb. On the other hand, the interface bandwidth of the memory system 310 may be very limited to 0.0625^{s-1} (=32 GB/s (@PCIe5.0×8)/512 GB). This bandwidth difference can limit the input/output performance of the data processing apparatus.

To overcome above-described issues, the memory system 310 may include a Memory controller 312 (e.g., a CXL™ core) designed and used for near data processing (NDP) (or near-distance data processing). The near data processing (NDP) can be a computing scheme for improving or enhancing the efficiency of data processing. The near data processing (NDP) could be based on a configuration in which the memory controller 312 (e.g., at least one processor or core that processes data) is arranged or located close to a data storage or memory such as the memory device 314.

In one type of computing model that has been proposed, the host central processing unit (CPU) 104 would retrieve data from the memory device 314 coupled to expand the host memory 106, process the data, and store results back in the memory device 314. However, in applications that require processing a large amount of data, that scheme could cause a bandwidth bottleneck between the memory device 314 and the host central processing unit (CPU) 104. To solve this issue, the near data processing (NDP) can be designed to place the memory controller 312 (e.g., a processor that processes data) close to the memory device 314 in which the processed data is stored. That is, instead of moving data from the memory device 314 to the host central processing unit (CPU) 104, the memory controller 312, which is the processor that performs data processing, can be included in the memory system 310 which is the location of the data. This configuration can significantly reduce or avoid delay time and energy consumption due to data movement.

Unlike the memory system 310, the host memory 106 can be used for in-memory processing of the host central processing unit (CPU) 104. In-memory processing can store as much data as possible in the host memory 106 and reduce the delay time due to disk I/O (e.g., I/O of the memory system). The host memory 106 under this scheme could support great performance in database work, real-time analysis, etc. However, because the host memory 106 is expensive and has limited capacity, there may be limitations in processing very large data sets. Thus, the data processing apparatus can overcome some limitations of operation and performance of the host memory 106 through the memory system 310 including the memory controller 312 for the near data processing (NDP).

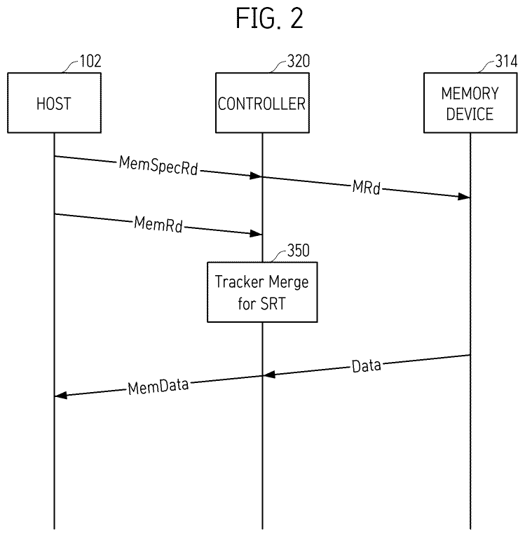

FIG. 2 illustrates an operation of a memory system 310 according to an embodiment of the present disclosure.

Referring to FIG. 2, the host 102 may interact with a controller 320 and the memory device 314. In one embodiment, the controller 320 can include the memory controller 312 described in FIG. 1, or the controller 320 can be included in the memory controller 312.

In order to reduce access latency to the memory device 314, the host 102 can transmit a speculative read request MemSpecRd to the controller 320 to initiate memory access before checking coherence. Depending on an embodiment, the controller 320 might not output a response or completion message for the speculative read request MemSpecRd to the host 102. Depending on an embodiment, the speculative read request MemSpecRd can further include additional information or data (e.g., Tag, MetaField, MetaValue, SnpType), etc. In an embodiment, the speculative read request MemSpecRd can include, or be transferred along with, information regarding a residual time SRT for which the controller 320 may temporarily store speculatively read data in a buffer. Depending on an embodiment, the speculative read request MemSpecRd can include, or be transferred along with, a variable or information that may adjust or change the residual time SRT.

In order to support the saving of latency for the read request MemRd of the host 102, the CXL-based protocol (e.g., CXL.mem) can provide the speculative read request MemSpecRd that is used to initiate memory access before a home agent in the host 102 verifies coherence. In an embodiment, CXL-based devices of the second type (Type 2) or the third type (Type 3) can perform an operation based on the speculative read request MemSpecRd. The home agent in the host 102 can arbitrarily delete transmission of the speculative read request MemSpecRd without receiving the completion message for the speculative read request MemSpecRd. The host 102 can issue the read request MemRd after verifying the coherence.

Referring to FIG. 2, the host 102 may transmit the speculative read request MemSpecRd to the controller 320. In response to the speculative read request MemSpecRd, the controller 320 can transmit a memory read command MRd to the memory device 314. Thereafter, the host 102 may transmit the read request MemRd to the controller 320.

The controller 320 can check whether a data address transmitted with the read request MemRd is included in a data address transmitted with the memory read command MRd already transmitted to the memory device 314 based on the speculative read request MemSpecRd (Tracker Merge, 350). When the data address transmitted together with the read request MemRd is included in the data address transmitted together with the memory read command MRd already transmitted to the memory device 314 based on the speculative read request MemSpecRd, the controller 320 does not have to transmit a memory read command MRd corresponding to the read request MemRd to the memory device 314. According to an embodiment, because the data received by, input to, the controller 320 based on the speculative read request MemSpecRd can be maintained for the residual time SRT during which the data can be temporarily stored in a buffer which is included in the controller 320 or operatively engaged with the controller 320, the tracker merge operation 350 of tracking the data and merging an operation for the read request MemRd could be performed within the residual time SRT.

While the controller 320 determines or decides whether to transmit, to the memory device 314, a memory read command MRd corresponding to the read request MemRd input from the host 102, the memory device 314 can output, to the controller 320, data corresponding to the memory read command MRd, previously transmitted based on the speculative read request MemSpecRd. When data corresponding to the read request MemRd input from the host 102 has been secured by the speculative read request MemSpecRd, the controller 320 can output, to the host 102, read data MemData corresponding to the read request MemRd.

Because the controller 320 has transmitted a memory read command MRd to the memory device 314 based on the speculative read request MemSpecRd, the read data MemData corresponding to the read request MemRd input from the host 102 after the speculative read request MemSpecRd could be output to the host 102 more quickly. This operation can improve the read operation performance of the memory system including the controller 320 and the memory device 314.

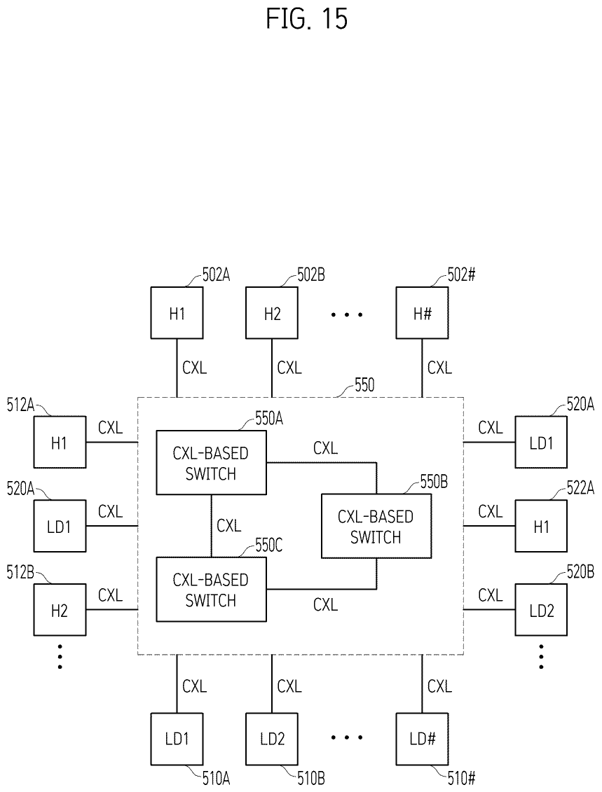

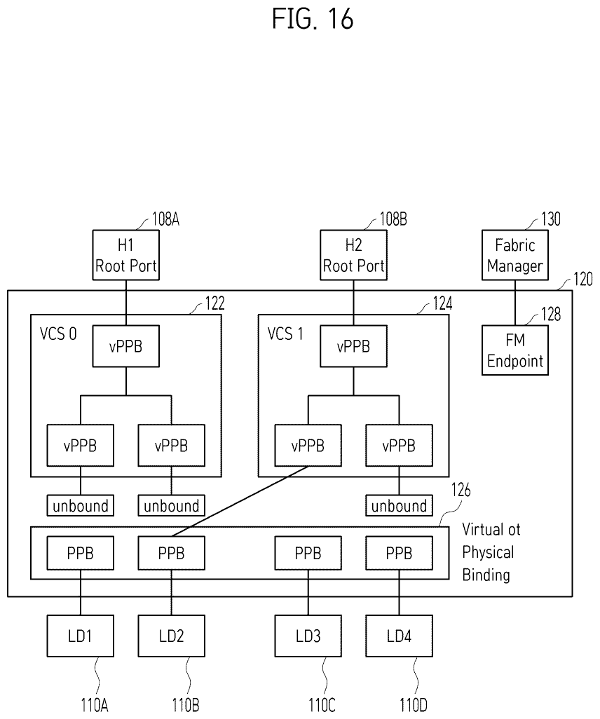

In an embodiment, the speculative read request MemSpecRd can be observed while another memory access to a same cache line address is in progress in the memory system 310. In this embodiment, the memory system 310 can erase, delete, or ignore the speculative read request MemSpecRd. To avoid affecting the performance of the memory system 310, the speculative read request MemSpecRd could be processed with a low priority. Based on a priority, the latency in response to an access request or command of the host 102 could be reduced. In an embodiment, processing of the speculative read request MemSpecRd can be controlled by the controller 320 or a CXL switch described in FIGS. 15 and 16. Because the speculative read request MemSpecRd may consume additional bandwidth, the memory system 310 according to an embodiment of the present disclosure might not perform an operation for the speculative read request MemSpecRd when it is determined that the data input/output performance could be degraded.

After performing the operation for the speculative read request MemSpecRd, the controller 320 can temporarily store, in a buffer, data input from the memory device 314. There is a limit to a total size of the buffer operated by the controller 320. The more data corresponding to the speculative read request MemSpecRd which is stored in the buffer, the smaller the size of the buffer that could be used or allocated for other data input/output commands such as a read command or a write command other than the speculative read request MemSpecRd. In addition, if the host 102 does not request the data secured in advance by the speculative read request MemSpecRd, the controller 320 would waste limited resources. Thus, based on the additional information corresponding to the speculative read request MemSpecRd, such as the residual time SRT that the controller 320 can temporarily store in the buffer, or a variable that can adjust or change the residual time SRT, the controller 320 can determine the time to hold, keep, or maintain the data secured in the buffer from the memory device 314 in advance by the speculative read request MemSpecRd. This scheme can also ensure that the host 102 can be more involved in reducing the access latency of the memory system 310 through the speculative read request MemSpecRd.

According to an embodiment, a Type 2 CXL-based device supporting the CXL-based protocol or CXL-based interface can be coupled to a memory such as DDR, high bandwidth memory (HBM), etc., in addition to a fully coherent cache. The Type 2 CXL-based device can control data input/output operations for the memory device 314, so that the memory device 314 coupled to an accelerator, etc. can provide a high bandwidth. In an embodiment, the Type 2 CXL-based device can provide a means for the host 102 to push an operand to the memory device 314 and prevent the host 102 from adding a result to the memory device 314. The Type 2 CXL-based device can handle many copies being sent and received from the host memory 106 to the memory device 314 when fetching operands and rewriting results.

A Type 3 CXL-based device supporting the CXL-based protocol or CXL-based interface can support communication under CXL.io and CXL.mem protocols. The Type 3 CXL-based device can be used as a memory expander. The Type 3 CXL-based device can primarily provide operations corresponding to requests sent from the host 102 via the CXL.mem protocol rather than via the CXL.cache protocol. The Type 3 CXL-based device can support operation under a CXL.io protocol which is used for device discovery, enumeration, error reporting, and management. Additionally, the CXL.io protocol can be used to allow the memory system 310 to be used for other IO specific application purposes.

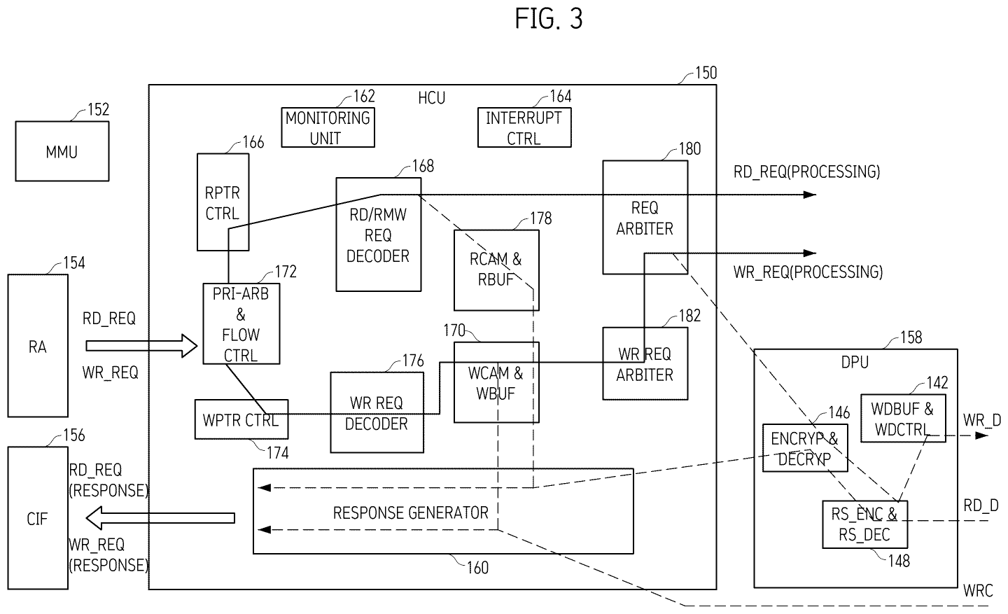

FIG. 3 illustrates a configuration of a controller according to an embodiment of the present disclosure.

Referring to FIG. 3, the controller can include a memory management unit (MMU) 152, a hazard control unit (HCU) 150, and a data processing unit 158 (DPU). The CXL device can further include a register allocation (RA) unit 154, and a control and status register interface (CIF) 156. According to an embodiment, the controller described in FIG. 3 can be included in the memory controller 312 described in FIG. 1, the controller 320 described in FIG. 2, or the CXL-based switch described in FIG. 15.

For example, the hazard control unit (HCU) 150 can play a role in detecting and resolving various types of hazards occurring within the controller 320. Various components related to the hazard control unit 150 can interact for efficient operation of the controller 320. The hazard control unit 150 can be a component for detecting and resolving various types of hazards that might occur in a pipeline processing within the controller 320. The pipeline processing is a technique for improving processing speed by dividing instructions into multiple stages and processing the instructions simultaneously through a pipeline. Data hazards, control hazards, and structural hazards might occur in pipeline processing.

The data hazards can occur when data required while a current instruction is being executed is not yet prepared by a previous instruction. To solve this situation, the hazard control unit 150 can delay the execution of the current instruction until the required data is prepared or can directly transfer the required data through a data forwarding technique.

The control hazards can occur when it is necessary to determine which instruction to execute next before a result of a branch instruction (e.g., jump, branch, etc.) is determined. To solve this situation, the hazard control unit 150 can use a branch prediction technique to predict the outcome of a branch. If the prediction is incorrect, the hazard control unit 150 can cancel incorrectly executed instructions and execute instructions on a correct path.

The structural hazards can occur when hardware resources in the pipeline of the controller 320 are insufficient but multiple instructions attempt to use insufficient resources at the same time. For example, multiple instructions could be transmitted to an instruction input/output device that can execute only one instruction at a time. To solve this situation, the hazard control unit 150 can delay the execution of the instruction until necessary resources become available for the corresponding instruction.

According to an embodiment, the memory management unit (MMU) 152 can perform an operation of translating a virtual memory address (e.g., a logical address) into a physical memory address. The memory management unit (MMU) 152 can provide an independent virtual memory space for each operation to enable memory protection and efficient memory use. The memory management unit (MMU) 152 can use a cache mechanism such as a Translation Lookaside Buffer (TLB) to reduce memory access delay that may occur during the address translation operation. The hazard control unit (HCU) 150 can reduce the impact of memory access delay that occurs in the memory management unit MMU 152 on the pipeline included in the controller 320.

According an embodiment, the register allocation unit (Register Alias Table or Register Allocation (RA), 154) can allocate registers that the controller 320 uses or provides to an external device. Further, the register allocation unit (RA) 154 can perform operations related to registers. For example, the register allocation unit 154 can support an operation in which a compiler or hardware performs mapping between a program variable and a physical register. In addition, the register allocation unit 154 can resolve data dependency and optimize parallel processing through register renaming. The hazard control unit 150 can help detect and resolve data hazards that may occur during a register allocation operation performed by the register allocation unit 154. When the register allocation unit 154 resolves data dependency through register renaming, the hazard control unit 150 can improve or maintain the efficiency of the pipeline in the controller 320.

The control and status (control/status) register interface (or configuration interface (CIF), 156) can provide an interface that can access control and status registers in the controller 320. The control and status registers can be used to provide information for system configuration, debugging, performance monitoring, etc. The controller 320 can adjust or change an operation based on the information (or values) stored in the control and status registers. The hazard control unit 150 can check the control and status information of the controller 320 through the control/status register interface 156 and then adjust operations performed in the pipeline based on the control and status information. For example, when a branch prediction in the pipeline fails, the control/status register interface 156 can update the status registers and re-execute the correct instruction.

Referring to FIG. 3, the hazard control unit 150 can include a monitoring unit 162 and an interrupt control (CTRL) unit 164. The monitoring unit 162 can monitor or track the overall operation of the hazard control unit 150. The interrupt control unit 164 can urgently control an internal operation of the hazard control unit 150 based on an interrupt signal transmitted from an external device.

According to an embodiment, the hazard control unit 150 can include a flow controller (FLOW CTRL) 172, a first decoder 168, a read buffer (RBUF) 178, an arbiter 180, and a response generator 160. The flow controller 172 may determine an operation order or sequence for plural requests including a speculative read request MemSpecRd and a read request RD_REQ (see FIG. 2). The first decoder 168 may identify a target of the speculative read request MemSpecRd or the read request RD_REQ. The read buffer 178 may store at least one data received from at least one memory device based on the speculative read request MemSpecRd or the read request RD_REQ. The arbiter 180 may transmit a control signal corresponding to the speculative read request MemSpecRd or the read request RD_REQ to at least one memory device. The response generator 160 may generate a response corresponding to the read request RD_REQ based on at least one data stored in the read buffer 178.

According to an embodiment, the hazard control unit 150 can detect and resolve the control hazards for not only the read request RD_REQ but also a write request WR_REQ. The flow controller 172 can determine an operation order or sequence of the read request RD_REQ and the write request WR_REQ. The hazard control unit 150 can further include a second decoder 176 configured to check a location where data corresponding to the write request WR_REQ is to be stored, a write buffer 170 where write data is stored, a write request (WR REQ) arbiter 182 configured to process the write request WR_REQ, etc.

According to an embodiment, the flow controller 172 can further include a priority buffer (e.g., Priority Content-Addressable Memory, PCAM) configured to check a priority for a data input/output request transmitted. The priority buffer (PCAM) can have a memory structure that quickly searches for data according to a specific condition. The priority buffer (PCAM) can be mainly used to resolve data hazards. The priority buffer (PCAM) can reduce waiting time and improve performance by quickly searching and providing necessary data or commands in the pipeline.

According to an embodiment, the hazard control unit 150 can further include a read pointer controller (e.g., read pointer controller (RPTR CTRL), 166) configured to manage a pointer for reading data from a memory buffer to adjust a read operation in the pipeline to prevent data hazards, and a write pointer controller (e.g., write pointer controller (WPTR CTRL), 174) configured to manage a pointer for writing data to the write buffer 170 to adjust a write operation to avoid structural hazards and data hazards. The read pointer controller 166 can check whether the data that is the target of the read request RD_REQ is ready and adjust the read operation to avoid data collisions. For example, the read pointer controller 166 can check whether the target of the read request RD_REQ is stored in the read buffer 178 through a speculative read request MemSpecRd. In addition, the write pointer controller 174 can adjust the pointer to store the write data in a correct memory location, and can avoid a collision by delaying a write operation when necessary.

The read buffer 178 can include a Read Content-Addressable Memory (RCAM) specialized for the read operation, while the write buffer 170 can include a Write Content-Addressable Memory (WCAM) specialized for the write operation. The RCAM can quickly identify and manage the data that is the target of the read request RD_REQ. The WCAM can quickly identify and manage the location where the data corresponding to the write request WR_REQ will be written. The RCAM and the WCAM can avoid the data hazards and the control hazards and enhance or improve a processing speed during the operation of the hazard control unit 150 configured to process the read request RD_REQ and the write request WR_REQ.

The data processing unit 158 can include an encryption and decryption module 146, an error correction module 148, and a write data control module 142. The encryption and decryption module 146 may encrypt read data RD_D and write data WR_D or decrypt encrypted data output from the at least one memory device. The error correction module 148 may generate a parity for checking an error in read data RD_D or write data WR_D or to check and correct the error based on the parity. The write data control module 142 may temporarily store the write data WR_D corresponding to the write request WR_REQ and provide the write data WR_D to the at least one memory device.

Hereinafter, a procedure in which a read operation and a write operation are processed through the hazard control unit 150 included in the memory system 310 such as a memory system or the controller 320 coupled to the at least one memory device will be described.

FIG. 3 briefly describes processing of the read request RD_REQ and the write request WR_REQ transmitted to the hazard control unit 150 through the register allocation unit 154 as well as processing of the read data RD_D and the write data WR_D, using solid lines and dotted lines. The processing of the read request RD_REQ and the write request WR_REQ and the processing of the read data RD_D and the write data WR_D described in FIG. 3 can be adjusted and changed according to the embodiment.

For the read request RD_REQ, the read pointer controller 166 can check or verify whether a target of the read request RD_REQ is stored in the read buffer 178 and transmit a confirmation result to the first decoder 168 based on a verification result. The first decoder 168 can, based on the verification result, either transmit the read request RD_REQ to the arbiter 180 or transmit, to the response generator 160, the read request RD_REQ along with data already stored in the read buffer 178. When the target of the read request RD_REQ is stored in the read buffer 178, the response generator 160 can generate a read response RD_REQ (RESPONSE) for the read request RD_REQ together with data (i.e., the target) corresponding to the read request RD_REQ. According to an embodiment, the read response RD_REQ (RESPONSE) can be transmitted to the control/status register interface 156 and provided to the external device. When the target of the read request RD_REQ is not stored in the read buffer 178, the read request RD_REQ can be transmitted to the at least one memory device. Read data RD_D transmitted from the at least one memory device can be handled through the data processing unit 158. Based on the read data RD_D handled by the data processing unit 158, the response generator 160 can generate the read response RD_REQ (RESPONSE) corresponding to the read request RD_REQ.

For the write request WR_REQ, hazards could be resolved by avoiding collision with other data input/output requests such as the read request RD_REQ through the flow controller 172 and the arbiter 180 in the hazard control unit 150. In addition, the write operation can be controlled or adjusted by the write pointer controller 174, the second decoder 176, the write buffer 170 and the write request arbiter 182, so that the write data WR_D transmitted along with the write request WR_REQ could be stored in a correct location without any collision. The write data WR_D can be transmitted from the write buffer 170 to the at least one memory device through the data processing unit 158. When a write operation is completed in the at least one memory device, a write completion WRC can be transmitted to the hazard control unit 150. The response generator 160 in the hazard control unit 150 can generate a write response WR_REQ (RESPONSE) based on the write completion WRC. The write response WR_REQ (RESPONSE) can be transmitted to the control/status register interface 156 and provided to an external device.

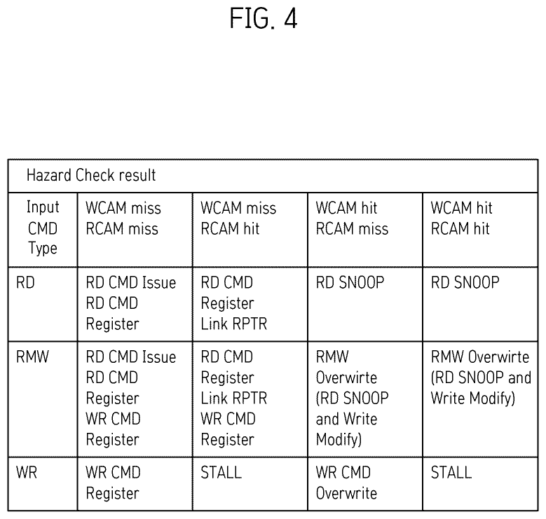

FIG. 4 illustrates a hazard control scheme regarding data input/output operations according to an embodiment of the present disclosure. Specifically, FIG. 4 illustrates an operation of the hazard control unit 150 described in FIG. 3 based on whether or not the read data RD_D and the write data WR_D are missed or hit (MISS, HIT) in the read buffer (e.g., RCAM) 178 and the write buffer (e.g., WCAM) 170 which are configured to temporarily store read data or write data.

Referring to FIG. 4, the hazard control unit 150 can perform an operation for hazard resolution for three different data input/output commands. The data input/output commands can include a read command RD, a write command WR, and a read-modify-write command RMW. The read buffer (e.g., RCAM) 178 and the write buffer (e.g., WCAM) 170 can have four states based on whether or not the read data RD_D and the write data WR_D are missed or hit (MISS, HIT).

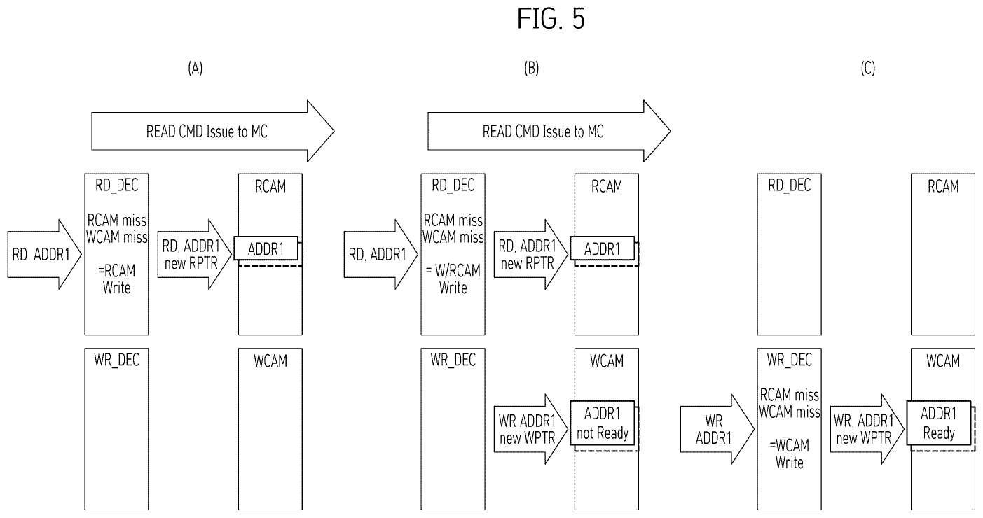

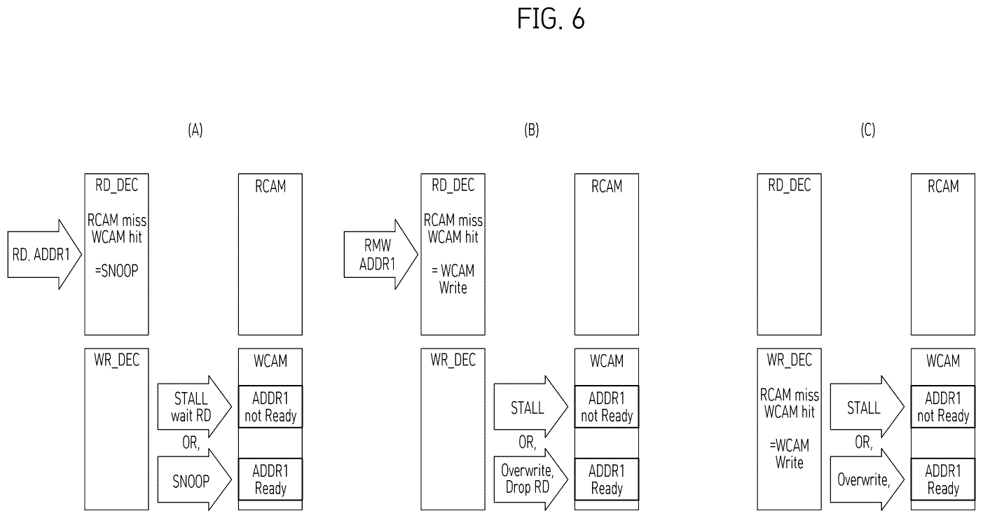

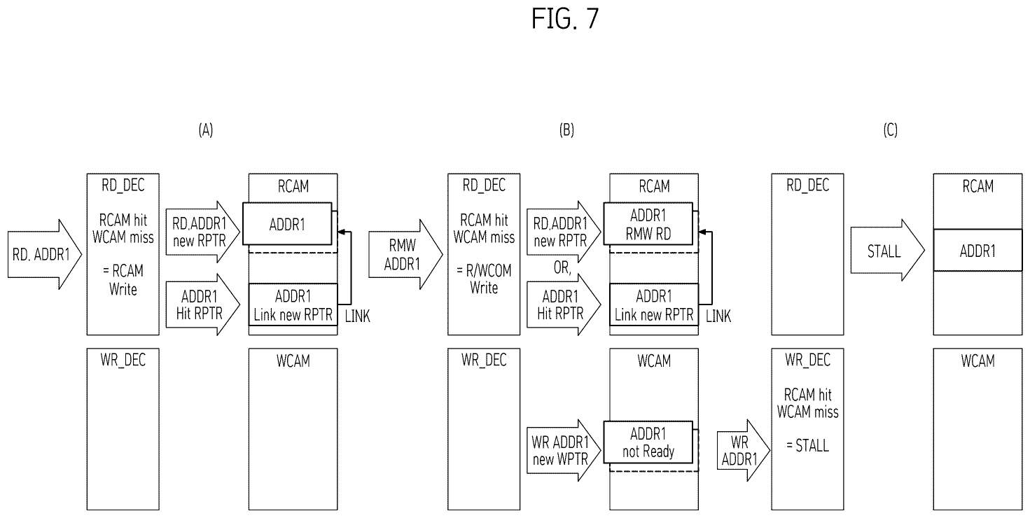

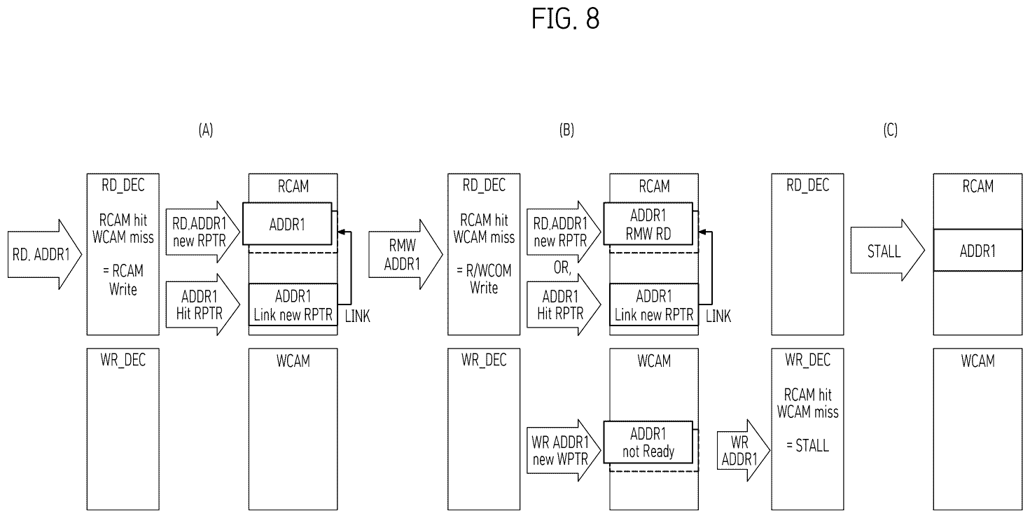

In relation to FIG. 4, FIG. 5 illustrates a first operation for hazard avoidance in a memory system according to an embodiment of the present disclosure, and FIG. 6 illustrates a second operation for hazard avoidance in a memory system according to an embodiment of the present disclosure. FIG. 7 illustrates a third operation for hazard avoidance in a memory system according to an embodiment of the present disclosure, and FIG. 8 illustrates a fourth operation for hazard avoidance in a memory system according to an embodiment of the present disclosure.

Referring to FIG. 4 and (A) of FIG. 5, when there is no data corresponding to the read command RD in the read buffer (e.g., RCAM) and the write buffer (e.g., WCAM) in response to the read command RD (i.e., RCAM MISS, WCAM MISS), the hazard control unit 150 can generate or transmit a read command (i.e., RD CMD ISSUE) and store or register the read command RD in the buffer (i.e., RD CMD Register). The read command RD and the address ADDR1 can be stored in a new read pointer (i.e., new RPTR). For example, if there is no data corresponding to the read command RD in the read buffer (e.g., RCAM) (i.e., RCAM MISS), it indicates that a target (i.e., data) of the read command RD is not included in data which is read and temporarily stored in the read buffer in response to a speculative read request MemSpecRd which is input earlier than the read command RD. When there is no data corresponding to the read command RD in the write buffer (e.g., WCAM) (i.e., WCAM MISS), it indicates that the target of the read command RD has not been recently stored in the at least one memory device through a write command WR or that the operation for the corresponding write command WR has been completed so that the target of the read command RD does not remain in the write buffer (e.g., WCAM). In this case, after the read command is transmitted to the at least one memory device, the hazard control unit 150 can match the read data RD_D delivered from the at least one memory device with the read command RD stored or registered in the buffer.

Referring to FIG. 4 and (B) of FIG. 5, if there is no data corresponding to the read command RD in the read buffer (e.g., RCAM) and the write buffer (e.g., WCAM) in response to a Read-Modify-Write command RMW (i.e., WCAM MISS, RCAM MISS), the hazard control unit 150 can generate or transmit the read command RD (i.e., RD CMD ISSUE), store or register the read command RD in the buffer (i.e., RD CMD Register), and store or register the write command WR in the buffer (i.e., WR CMD Register). At this time, the read command RD and the address ADDR1 can be stored in a new read pointer (i.e., new RPTR). For example, if there is no data corresponding to the read command RD in the read buffer (e.g., RCAM) (i.e., MISS), it indicates that the target of the read command RD is not included in data read and temporarily stored in the read buffer through the speculative read request MemSpecRd. In addition, if there is no data corresponding to the read command RD in the write buffer (e.g., WCAM) (i.e., MISS), it indicates that the target of the read command RD has not been recently stored in the at least one memory device through the write command WR or that the operation for the corresponding write command WR has been completed, so that the target of the read command RD does not remain in the write buffer. In this case, after the read command is transmitted to at least one memory device, the hazard control unit 150 can match the read data RD_D transmitted from the at least one memory device with the read command stored or registered in the buffer. In addition, because the read data RD_D could be modified and stored again in the at least one memory device based on the read-modify-write command RMW, the hazard control unit 150 can allocate the new write pointer (i.e., new WPTR) for the corresponding address ADDR1 to the write buffer (e.g., WCAM).

Referring to FIG. 4 and (C) of FIG. 5, when there is no data corresponding to the read command RD in the read buffer (e.g., RCAM) and the write buffer (e.g., WCAM) in response to a write command WR (i.e., WCAM MISS, RCAM MISS), the hazard control unit 150 can store or register the write command in the buffer (i.e., WR CMD Register). During the operation for the write command WR, the hazard control unit 150 can allocate a new write pointer (i.e., new WPTR) for the address ADDR1 input along with the write command WR to the write buffer (e.g., WCAM). Because a case where the address and data corresponding to the write command WR are in the read buffer (e.g., RCAM) (i.e., HIT) could cause a data collision, the write command WR could be easily handled in the case where there is no data corresponding to the read command RD in the read buffer (e.g., RCAM) (i.e., MISS).

Referring to FIG. 4 and (A) of FIG. 6, in response to a read command RD, there may be no data corresponding to the read command RD in the read buffer (e.g., RCAM) (i.e., RCAM MISS), but there may be data corresponding to the read command RD in the write buffer (e.g., WCAM) (i.e., WCAM HIT). In this case, the hazard control unit 150 can search for and monitor the target of the read command RD in the write buffer (e.g., WCAM) (i.e., RD SNOOP). For example, if there is no data corresponding to the read command RD in the read buffer (e.g., RCAM) (i.e., RCAM MISS), it indicates that a target of the read command RD is not included in the data read and temporarily stored in the read buffer through the speculative read request MemSpecRd. However, if there is data corresponding to the read command RD in the write buffer (e.g., WCAM) (i.e., WCAM HIT), it indicates that the target of the read command RD has been recently stored or is to be stored in the at least one memory device through the write command WR, and the target of the read command RD remains in the write buffer. In this case, the hazard control unit 150 does not need to transmit the read command to the at least one memory device. The hazard control unit 150 can match the data remaining in the write buffer (e.g., WCAM) with the read command RD as the read data RD_D.

It can be plausible that a write pointer (i.e., new WPTR) is allocated for data remaining in the write buffer (e.g., WCAM), based on a read-modify-write command (RMW), but the data is not yet ready to be performed (i.e., NOT READY). In this case, the hazard control unit 150 can temporarily stall or delay an operation or a task for corresponding data input/output in the pipeline (STALL, DELAY).

Referring to FIG. 4 and (B) of FIG. 6, in response to the Read-Modify-Write command RMW, there may be no data corresponding to the read command RD in the read buffer (e.g., RCAM) (i.e., RCAM MISS), but data corresponding to the read command RD may exist in the write buffer (e.g., WCAM) (i.e., WCAM HIT). In this case, the hazard control unit 150 can perform an overwrite of the write command WR in the write buffer (e.g., WCAM) (i.e., WR CMD OVERWRITE), find and monitor the target of the read command RD in the write buffer (e.g., WCAM) (i.e., RD SNOOP), and perform a write modification (i.e., WRITE MODIFY). For example, if there is no data corresponding to the read command RD in the read buffer (e.g., RCAM) (i.e., RCAM MISS), it indicates that a management authority for the target of the read command RD has already been transferred from the read buffer (e.g., RCAM) to the write buffer (e.g., WCAM). Because the Read-Modify-Write command RMW modifies data that has already been read, the read command RD according to the Read-Modify-Write command RMW might not be transmitted. However, if there is data corresponding to the read command RD in the write buffer (e.g., WCAM) (i.e., WCAM HIT), the hazard control unit 150 can perform the overwrite of the latest write command WR on the previously stored write pointer because both a write pointer for the write command WR according to the Read-Modify-Write command RMW and a write pointer already stored in the write buffer (e.g., WCAM) are set for storing data at a substantially same location. Through this operation, the hazard control unit 150 might not perform a write operation which is to be performed unnecessarily in the at least one memory device (i.e., the operation corresponding to the write pointer that has already been stored in the write buffer (e.g., WCAM)).

There may be a case where the data remaining in the write buffer (e.g., WCAM) corresponds to a Read-Modify-Write command RMW and the write pointer (i.e., new WPTR) has already been allocated to the write buffer (e.g., WCAM) but is not yet ready to be performed (i.e., NOT READY). In this case, the hazard control unit 150 can temporarily stall or delay the corresponding data input/output operation or task in the pipeline (i.e., STALL, DELAY).

Referring to FIG. 4 and (C) of FIG. 6, in response to a write command WR, there may be no data corresponding to the read command RD in the read buffer (e.g., RCAM) (i.e., RCAM MISS), but there may be data corresponding to the read command RD in the write buffer (e.g., WCAM) (i.e., WCAM HIT). In this case, because both the write pointer for the write command WR according to the Read-Modify-Write command RMW and the write pointer already stored in the write buffer (e.g., WCAM) are set for storing data at a substantially same location, the hazard control unit 150 can perform overwriting of the latest write command WR to the previously stored write pointer in the write buffer (e.g., WCAM).

There may be a case where the data remaining in the write buffer (e.g., WCAM) corresponds to the Read-Modify-Write command RMW and the write pointer (i.e., new WPTR) has already been allocated to the write buffer (e.g., WCAM) but is not yet ready to be performed (i.e., NOT READY). In this case, the hazard control unit 150 can temporarily stall or delay the corresponding data input/output operation or task in the pipeline (i.e., STALL, DELAY).

Referring to FIG. 4 and (A) of FIG. 7, in response to a read command RD, there may be data corresponding to the read command RD in the read buffer (e.g., RCAM) (i.e., RCAM HIT), and there may not be data corresponding to the read command RD in the write buffer (e.g., WCAM) (i.e., WCAM MISS). In this case, the hazard control unit 150 may register the read command RD and the address ADDR1 to a new read pointer (i.e., new RPTR) in the read buffer (e.g., RCAM) (i.e., RD CMD Register). Thereafter, the hazard control unit 150 can link the new read pointer (i.e., new RPTR) to data corresponding to the read command RD stored in the read buffer (e.g., RCAM) (i.e., LINK, Link RPTR). That is, because the target of the read command RD is already stored in the read buffer (e.g., RCAM), the hazard control unit 150 does not have to transfer the read command RD to at least one memory device associated with the address ADDR1.

Referring to FIG. 4 and (B) of FIG. 7, in response to a Read-Modify-Write command RMW, data corresponding to the read command RD can exist in the read buffer (e.g., RCAM) (i.e., RCAM HIT), and data corresponding to the read command RD might not exist in the write buffer (e.g., WCAM) (i.e., WCAM MISS). In this case, the hazard control unit 150 can register a read command (i.e., RMW RD) and an address ADDR1 according to the Read-Modify-Write command RMW at a new read pointer (i.e., new RPTR) in the read buffer (e.g., RCAM) (i.e., RD CMD Register). Thereafter, the hazard control unit 150 can link the new read pointer (i.e., new RPTR) to the data corresponding to the read command RD stored in the read buffer (e.g., RCAM) (i.e., LINK, Link RPTR). That is, because the target is already stored in the read buffer (e.g., RCAM) for the read command (RMW RD), the hazard control unit 150 does not have to transfer the read command (RMW RD) to at least one memory device associated with the address ADDR1. Because the Read-Modify-Write command RMW can include modification and writing of the read data, the hazard control unit 150 can allocate a new write pointer (i.e., new WPTR) for the input address ADDR1 to the write buffer (e.g., WCAM) along with the write command (RMW WR) based on the Read-Modify-Write command RMW. A task or operation for the newly allocated write pointer (i.e., new WPTR) in the write buffer (e.g., WCAM) might not be ready to be performed (i.e., Not Ready) until the write command (RMW WR) is performed after the corresponding data is modified.

Referring to FIG. 4 and (C) of FIG. 7, in response to a write command WR, data corresponding to the read command RD might exist in the read buffer (e.g., RCAM) (i.e., RCAM HIT), and data corresponding to the read command RD might not exist in the write buffer (e.g., WCAM) (i.e., WCAM MISS). In this case, the hazard control unit 150 can temporarily stall or delay the corresponding data input/output operation or task in the pipeline to avoid data hazard (STALL, DELAY). This is because a data collision could occur when the address and data corresponding to the write command WR exist in the read buffer (e.g., RCAM) (i.e., RCAM HIT).

Referring to FIG. 4 and (A) of FIG. 8, in response to a read command RD, there is data corresponding to the read command RD in the read buffer (e.g., RCAM) and the write buffer (e.g., WCAM) (i.e., WCAM HIT). The hazard control unit 150 can operate substantially similarly to the case described in (A) of FIG. 6 where there is no data corresponding to the read command RD in the read buffer (e.g., RCAM) (i.e., RCAM MISS) but there is data corresponding to the read command RD in the write buffer (e.g., WCAM) (i.e., WCAM HIT). In this case, the hazard control unit 150 can search for and monitor the target of the read command RD in the write buffer (e.g., WCAM) (i.e., RD SNOOP). For example, when the target of the read command RD can be found in the write buffer (e.g., WCAM) (i.e., WCAM HIT) even if there is data corresponding to the read command RD in the read buffer (e.g., RCAM) (i.e., RCAM HIT), the target of the read command RD might have been recently stored or is to be stored in at least one memory device. Thus, in order to avoid data hazard, the hazard control unit 150 can find and monitor the target of the read command RD in the write buffer (e.g., WCAM) (i.e., RD SNOOP), instead of transmitting the read command RD to the at least one memory device.

There may be a case where the data remaining in the write buffer (e.g., WCAM) corresponds to the read-modify-write command RMW or the write command WR and the write pointer (i.e., new WPTR) is allocated to the write buffer (e.g., WCAM) but is not yet ready to be performed (i.e., NOT READY). In this case, when the corresponding data is scheduled to be stored in at least one memory device but is not yet ready to be written, the hazard control unit 150 can temporarily stall or delay the corresponding data input/output operation or task in the pipeline (i.e., STALL, DELAY).

Referring to FIG. 4 and (B) of FIG. 8, the hazard control unit 150 can operate substantially similarly to the case described in (B) of FIG. 6 in response to a Read-Modify-Write command RMW, when there is data corresponding to the read command RD in the read buffer (e.g., RCAM) and the write buffer (e.g., WCAM) (i.e., RCAM HIT, WCAM HIT). When there is no data corresponding to the read command RD in the read buffer (e.g., RCAM) (i.e., RCAM MISS) but data corresponding to the read command RD is included in the write buffer (e.g., WCAM) (i.e., WCAM HIT), the hazard control unit 150 can perform an overwrite of the write command WR in the write buffer (e.g., WCAM) (i.e., WR CMD OVERWRITE), find and monitor a target of the read command RD in the write buffer (e.g., WCAM) (i.e., RD SNOOP), and perform a write modification (i.e., WRITE MODIFY). For example, if there is no data corresponding to the read command RD in the read buffer (e.g., RCAM) (i.e., RCAM MISS), it indicates that a management (or control) authority for the target of the read command RD has already been transferred from the read buffer (e.g., RCAM) to the write buffer (e.g., WCAM). Thus, because the Read-Modify-Write command RMW modifies data that has already been read, the read command RD corresponding to the Read-Modify-Write command RMW might not be transmitted to the at least one memory device. However, if there is data corresponding to the read command RD in the write buffer (e.g., WCAM) (i.e., WCAM HIT), the write pointer for the write command WR corresponding to the Read-Modify-Write command RMW and the write pointer already stored in the write buffer (e.g., WCAM) can be set for storing data at a substantially same location. The hazard control unit 150 can overwrite the latest write command WR with the previously stored write pointer. Through this operation, the hazard control unit 150 can avoid performing a write operation that is scheduled to be performed unnecessarily in the at least one memory device (i.e., an operation corresponding to the write pointer that has already been stored in the write buffer (e.g., WCAM)).

Referring to FIG. 4 and (C) of FIG. 8, when there is data corresponding to a read command RD in the read buffer (e.g., RCAM) and the write buffer (e.g., WCAM) (i.e., RCAM HIT, WCAM HIT) in response to a write command WR, the hazard control unit 150 can operate substantially similarly to the case described in (C) of FIG. 7 where there is data corresponding to the read command RD in the read buffer (e.g., RCAM) (i.e., RCAM HIT) and there is no data corresponding to the read command RD in the write buffer (e.g., WCAM) (i.e., WCAM MISS). In order to avoid data hazard, the hazard control unit 150 can temporarily stall or delay the corresponding data input/output operation or task in the pipeline (STALL, DELAY). This is because a data collision might occur when the address and data corresponding to the write command WR are in the read buffer (e.g., RCAM) (i.e., RCAM HIT).

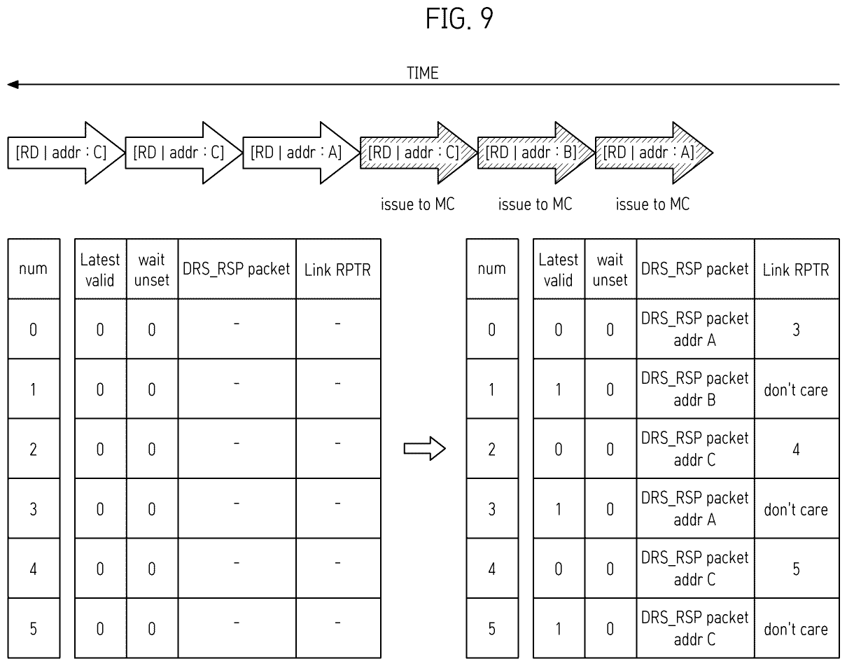

FIG. 9 illustrates a first operation of a read buffer in a memory system according to an embodiment of the present disclosure.

Referring to FIG. 9, a first operation in which a hazard control unit 150 registers a read command in a read buffer (i.e., RD CMD Register) is described.

The hazard control unit 150 can sequentially receive six read commands. First, the first read command is a read command for an address ‘A’ (RD|addr: A), the second read command is another read command for an address ‘B’ (RD|addr: B), and the third read command is another read command for an address ‘C’ (RD|addr: C). The fourth read command, which is input thereafter, is another read command for the address ‘A’ (RD|addr: A), the fifth read command is another read command for the address ‘C’ (RD|addr: C), and the sixth read command is another read command for the address ‘C’ (RD|addr: C). When a read command in the hazard control unit 150 is registered first, the corresponding read command (or a control signal) can be generated and transmitted to at least one memory device.

The first read command for the address ‘A’ can be stored or registered at a first location (e.g., num=0) in the read buffer. Because the first read command is a first command for the address ‘A’, the first read command could be issued and transferred to a memory controller MC coupled to at least one memory device (i.e., issue to MC). Before the fourth read command is input, among the attributes of the first read command, a latest validity value (i.e., Latest valid) indicating which one is the latest command could be set to ‘1’. When the latest valid value (i.e., Latest valid) of the first read command is ‘1’, a value of a link read pointer (i.e., Link RPTR) can become meaningless (i.e., don't care).

Thereafter, the second read command for the address ‘B’ can be stored at a second location (i.e., num=1) in the read buffer. Because the second read command is a first command for the address ‘B’, the second read command could be issued and transferred to the memory controller MC coupled to the at least one memory device (i.e., issue to MC). Among the attributes of the second read command, a latest validity value (i.e., Latest valid) can be set to ‘1’. When the latest validity value of the second read command is ‘1’, a value of the link read pointer (i.e., Link RPTR) can become meaningless (i.e., don't care).

After that, the third read command for the address ‘C’ can be stored at a third location (i.e., num=2) in the read buffer. Because the third read command is a first command for the address ‘C’, the third read command can be issued and transferred to the memory controller MC coupled to the at least one memory device (i.e., issue to MC). Among the properties of the third read command, the latest validity value can be set to ‘1’. Before the fifth read command is input, when the latest validity value of the third read command is ‘1’, a value of the link read pointer (i.e., Link RPTR) can become meaningless (i.e., don't care).

After that, when the fourth read command for the address ‘A’ is input, the fourth read command can be stored at a fourth location (e.g., num=3) in the read buffer. Because the first read command for the address ‘A’ was transferred to the memory controller MC, the fourth read command might be not transferred to the memory controller MC. In addition, because both the fourth read command and the first read command are read commands for a same address, the Link RPTR among the attributes of the first read command may be changed to a value pointing to the fourth location (e.g., num=3) where the fourth read command is stored. In addition, because the fourth read command was input after the first read command, the latest validity value among the attributes of the first read command can be modified from ‘1’ to ‘0’, and the latest validity value of the fourth read command can be set to ‘1’. When the latest validity value of the fourth read command is set to ‘1’, a value of the Link RPTR can become meaningless (i.e., don't care).

Afterwards, when the fifth read command for the address ‘C’ is input, the fifth read command can be stored (i.e., registered) at a fifth location (e.g., num=4) in the read buffer. Because the third read command for the address ‘C’ has been transmitted to the memory controller MC, the fifth read command does not have to be transmitted to the memory controller MC. In addition, since the fifth read command and the third read command are read commands for the same address, the Link RPTR among the attributes of the third read command may be changed to a value pointing to the fifth location (i.e., num=4) where the fifth read command is registered. In addition, because the fifth read command was input after the third read command, the Latest valid among the attributes of the third read command can be modified from ‘1’ to ‘0’, and the Latest valid of the fifth read command can be set to ‘1’. If the Latest valid of the fifth read command is set to ‘1’ before the sixth read command is input, the value of the Link RPTR can become meaningless (i.e., don't care).

Thereafter, when the sixth read command for the address ‘C’ is input, the sixth read command can be registered at a sixth location (e.g., num=5) in the read buffer. Because at least one read command for the address ‘C’ (i.e., the third read command) has already been sent to the memory controller MC, the sixth read command is not sent to the memory controller MC. Further, because the sixth read command and the fifth read command whose latest valid value is ‘1’ are read commands for the same address, the Link RPTR among the attributes of the fifth read command can be changed to a value pointing to the sixth location (i.e., num=5) where the sixth read command is stored. In addition, since the sixth read command was input after the fifth read command, the Latest valid among the attributes of the fifth read command can be changed from ‘1’ to ‘0’, and the Latest valid of the sixth read command can be set to ‘1’. When the Latest valid of the sixth read command is set to ‘1’, the value of the Link RPTR can become meaningless (i.e., don't care).

According to an embodiment, after the first to sixth read commands are registered in the read buffer, the hazard control unit 150 can search for a pointer RPTR for preparing a read response for a read command whose latest valid is ‘0’ until a read command whose latest valid is ‘1’ is found. For example, if data stored at and read from the address ‘A’ is transmitted in response to the first read command, the hazard control unit 150 can search for up to the fourth read command whose latest valid is ‘1’ based on the pointer RPTR, for preparing a read response, because the latest valid of the first read command is ‘0’. The hazard control unit 150 can add the data read from the address ‘A’ into responses corresponding to the first and fourth read commands. Likewise, when the data stored at the address ‘C’ corresponding to the third read command is transmitted, the hazard control unit 150 can find the sixth read command whose latest valid value (Latest valid) is set to ‘1’ based on the pointer RPTR, for preparing a read response, because the latest valid value (Latest valid) of the third read command is set to ‘0’. The hazard control unit 150 can add the data read from the address ‘C’ into responses corresponding to the third read command, the fifth read command, and the sixth read command.

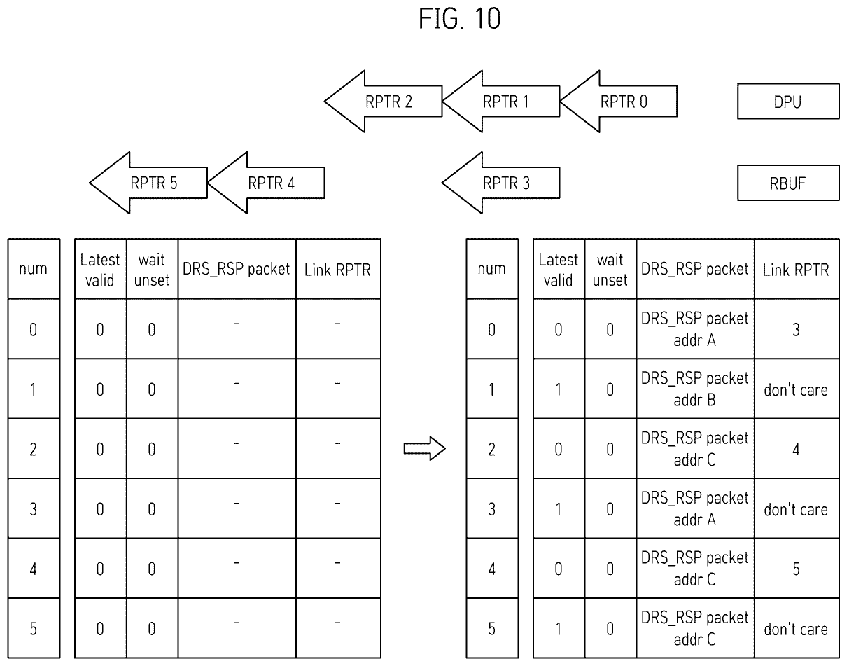

FIG. 10 illustrates a second operation of a read buffer in a memory system according to an embodiment of the present disclosure. Specifically, FIG. 10 describes operations of the hazard control unit 150, which prepares a response to the read command, and a procedure of emptying or releasing the read buffer.

Referring to FIGS. 9 and 10, among the first to sixth read commands, the first to third read commands can be transmitted to a memory controller MC (i.e., issued to MC). Responses RPTR0, RPTR1, RPTR2 corresponding to the first to third read commands can be transmitted through the data processing unit (DPU) 158 as shown in FIG. 3. The first to third responses RPTR0, RPTR1, RPTR2 corresponding to the first to third read commands can include data read from memory cells indicated by the addresses ‘A’, ‘B’, ‘C’ input along with the first to third read commands.

When the first response RPTR0 is generated, the hazard control unit 150 can remove or release the first read command corresponding to the first response RPTR0 from the read buffer. At this time, since the value of the link read pointer (i.e., Link RPTR) among the properties of the first read command is stored in the fourth location (i.e., num=3), the hazard control unit 150 can notify the response generator 160 (see FIG. 3) to additionally generate a response for the fourth read command stored in the fourth location (i.e., num=3). The fourth response RPTR3 corresponding to the fourth read command can be added to the response buffer RBUF managed by the response generator 160. When the fourth response RPTR3 is added to the response buffer RBUF, the fourth read command can be removed from the read buffer.

After the second response RPTR1 is generated for the second read command RPTR1, the hazard control unit 150 can remove the second read command corresponding to the second response RPTR1 from the read buffer RBUF.

When the third response RPTR2 is generated, the hazard control unit 150 can release the third read command corresponding to the third response RPTR2 from the read buffer. At this time, because the value of the link read pointer (i.e., Link RPTR) among the attributes of the third read command is stored in the fifth position (i.e., num=4), the hazard control unit 150 can notify the response generator 160 (see FIG. 3) to additionally generate a response for the fifth read command registered in the fifth position (i.e., num=4). The fifth response RPTR4 corresponding to the fifth read command can be added to the response buffer RBUF managed by the response generator 160. In addition, since the value of the link read pointer (i.e., Link RPTR) among the attributes of the fourth read command is registered in the sixth position (i.e., num=5), the hazard control unit 150 can notify the response generator 160 to additionally generate a response for the sixth read command stored in the sixth position (i.e., num=5). The sixth response RPTR5 corresponding to the sixth read command can be added to the response buffer RBUF managed by the response generator 160. When the fifth response RPTR4 and the sixth response RPTR5 are added to the response buffer RBUF, both the fifth read command and the sixth read command can be removed or released from the read buffer RBUF.

A response to a read command can be generated and added simultaneously through the data processing unit (DPU) 158 and the response buffer RBUF, in which case the control/status register interface 156 (see FIG. 3) can preferentially process the response generated through the data processing unit (DPU) 158.

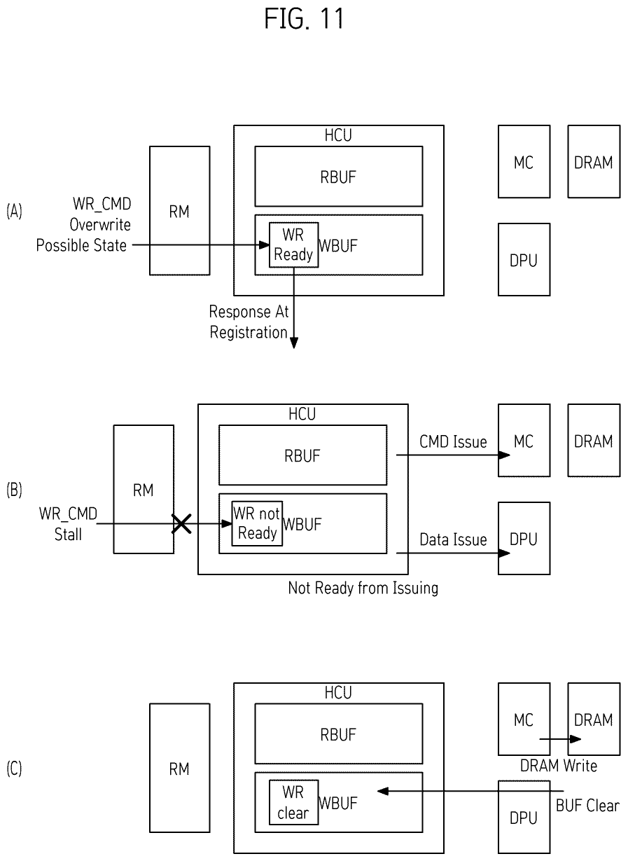

Referring to FIGS. 4 to 8, the operations performed in response to data input/output requests by the hazard control unit (HCU) 150 to avoid hazards can be distinguished. Hereinafter, with reference to FIGS. 11 to 14, a timing at which the hazard control unit HCU generates a response corresponding to the data input/output request will be specifically described. The hazard control unit HCU can include the read buffer RBUF and the write buffer WBUF. The hazard control unit HCU can interact with the resource manager RM, the memory controller MC, and the data processing unit DPU.

FIG. 11 illustrates a first operation for generating a response in a memory system according to an embodiment of the present disclosure. The first operation can include a process or task for generating a response in response to a state of a write buffer.

As described in FIG. 4, the hazard control unit HCU can perform an overwrite of a write command WR in the write buffer WBUF (i.e., WR CMD OVERWRITE). Referring to (A) of FIG. 11, when a write command WR prepared to be executed is registered in the write buffer WBUF in order that the hazard control unit HCU performs an overwrite of the write command WR on the write buffer WBUF (i.e., WR CMD OVERWRITE), the hazard control unit HCU can generate a response corresponding to the write command WR as soon as the write command WR is registered in the write buffer WBUF (e.g., early completion).

Referring to (B) of FIG. 11, there is a pause state (i.e., Stall) in which a write command WR is registered in the write buffer WBUF but execution of the write command WR is stalled or delayed. After the pause state, the hazard control unit HCU can issue a write command to the memory controller MC (i.e., CMD Issue) and can issue write data to the data processing unit (DPU) 158 (i.e., Data Issue). In this case, no response to the write command WR is generated.

Referring to (C) of FIG. 11, after the memory controller MC issues a write command to at least one memory device (e.g., DRAM) (i.e., DRAM Write), a completion signal or a buffer release signal (e.g., BUF Clear) for the write operation (i.e., DRAM Write) can be issued to the hazard control unit HCU. The hazard control unit HCU can remove the write command from the write buffer WRUF (i.e., WR clear).

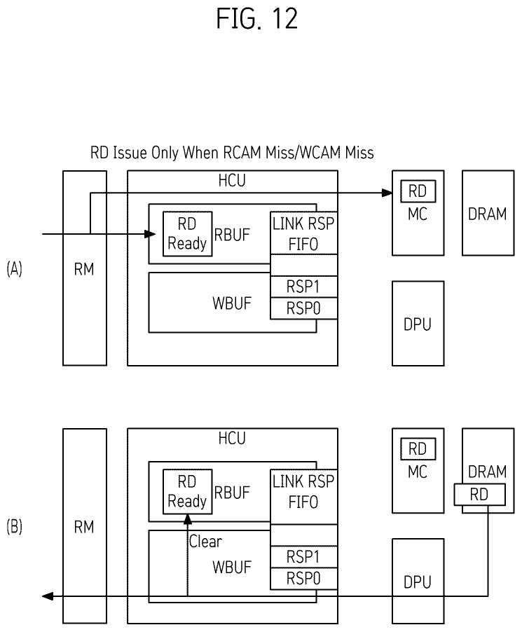

FIG. 12 illustrates a second operation for generating a response in a memory system according to an embodiment of the present disclosure. The second operation describes a case where a read command RD is transmitted to at least one memory device (e.g., DRAM) during a read operation.

Referring to (A) of FIG. 12, the hazard control unit HCU receiving the read command RD can transmit the read command RD to the memory controller MC (i.e., RD Issue) only when there is no data corresponding to the read buffer (RCAM, RBUF) and the write buffer (WCAM, WBUF) (i.e., RCAM Miss, WCAM Miss).

Referring to (B) of FIG. 12, when at least one memory device (e.g., DRAM), after receiving the read command RD, transfers data corresponding to the read command RD to the hazard control unit HCU, the hazard control unit HCU can release the read command RD stored in the read buffer after outputting a response corresponding to the read command RD (see FIG. 10).

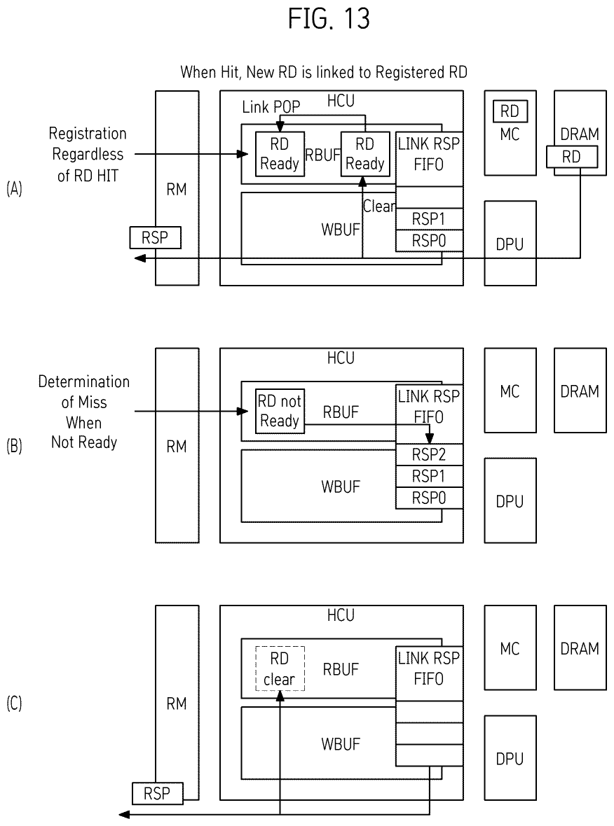

FIG. 13 illustrates a third operation for generating a response in a memory system according to an embodiment of the present disclosure. The third operation describes a case where a read command RD is not transmitted to at least one memory device (e.g., DRAM) during a read operation.

Referring to (A) of FIG. 13, the hazard control unit HCU that receives the read command RD can first register the read command RD in the read buffer RBUF. Thereafter, if a target of the registered read command RD exists in the read buffer (e.g., data corresponding to the same address has been read), the hazard control unit HCU can link or map the registered read command RD to the read command which has been performed (i.e., Link POP). When at least one memory device (e.g., DRAM), after receiving the read command RD, transmits data corresponding to the read command RD to the hazard control unit HCU, the hazard control unit HCU can release the read command registered or stored in the read buffer (i.e., Clear) after outputting a response RSP corresponding to the read command RD.

Referring to (B) of FIG. 13, the hazard control unit HCU that receives the read command RD can first register the read command RD in the read buffer RBUF. When the registered read command RD is not ready to be executed (i.e., RD NOT Ready) even though a target of the registered read command RD exists in the read buffer, the hazard control unit HCU can consider that the target of the registered read command RD does not exist in the read buffer (i.e., Miss). In this case, the hazard control unit HCU can temporarily stall or delay execution of the corresponding operation or task.

Referring to (C) of FIG. 13, when the hazard control unit HCU receives data corresponding to the read command RD that has been temporarily stalled or delayed by the hazard control unit HCU, the hazard control unit HCU can generate and output a response RSP and, then, remove the corresponding read command RD from the read buffer RBUF (i.e., RD Clear).

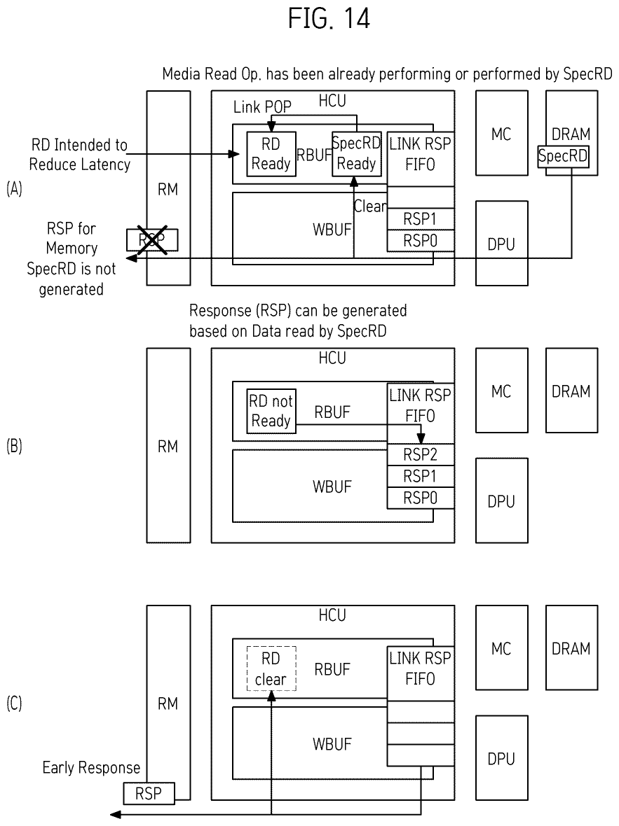

FIG. 14 illustrates a fourth operation for generating a response in a memory system according to an embodiment of the present disclosure. The fourth operation describes operations that may vary based on the speculative read request MemSpecRd (see FIG. 2) during a read operation.

Referring to (A) of FIG. 14, after the hazard control unit HCU transmits a speculative read request SpecRd to at least one memory device (e.g., DRAM), the at least one memory device can transmit data to the hazard control unit HCU based on the speculative read request SpecRd. The hazard control unit HCU does not generate a response RSP corresponding to the speculative read request SpecRd. However, the hazard control unit HCU can clear the speculative read request SpecRd stored or registered in the read buffer. When a read command RD is input to the hazard control unit HCU after the speculative read request SpecRd which is intended to reduce access latency, the hazard control unit HCU after receiving the read command RD can first register the read command RD in the read buffer RBUF. Afterwards, because a target of the registered read command RD exists in the read buffer (i.e., the speculative read request SpecRd and the read command RD are input to read data stored at a same address), the hazard control unit HCU can link the read command RD and the speculative read request SpecRd (i.e., Link POP).

Referring to (B) of FIG. 14, the hazard control unit HCU that has once registered the read command RD in the read buffer RBUF can determine that the corresponding read command RD is not ready to be executed (i.e., RD NOT Ready). The hazard control unit HCU can find a target of the read command RD among the data, read and collected based on the speculative read request SpecRd, and generate a response corresponding to the read command RD based on a search result.

Referring to (C) of FIG. 14, after the response RSP is generated by the hazard control unit HCU, the hazard control unit HCU can output the response RSP and remove the corresponding command from the read buffer RBUF (i.e., RD Clear).

FIG. 15 illustrates a data infrastructure according to an embodiment of the present disclosure. Specifically, FIG. 15 illustrates a plurality of hosts, a plurality of logical devices, a Compute Express Link-based (CXL-based) switch, and a Compute Express Link-based (CXL-based) interface included in the data infrastructure.

Referring to FIG. 15, the data infrastructure can include a plurality of hosts (or host systems) (H1, H2, . . . . H #) 502A, 502B, . . . , 502 #, 512A, 512B, 522A and a plurality of logical devices (LD1, LD2, . . . . LD #) 510A, 510B, . . . , 510 #, 520A, 520B. The plurality of hosts 502A, 502B, . . . , 502 #, 512A, 512B, 522A and the plurality of logical devices 510A, 510B, . . . , 510 #, 520A, 520B can be coupled by a connection device 550 including at least one CXL-based switch 550A, 550B, 550C.

Data infrastructure may refer to a digital infrastructure that promotes data sharing and consumption. Like other infrastructures, the data infrastructure can include structures, services, and facilities that are necessary for data sharing and consumption. For example, the data infrastructure includes a variety of components, including hardware, software, networking, services, policies, and etc. that enable data consumption, storage, and sharing. The data infrastructure can provide a foundation for creating, managing, using, and protecting data.

For example, the data infrastructure can be divided into physical infrastructure, information infrastructure, business infrastructure, and the like. The physical infrastructure may include a data storage device, a data processing device, an input/output network, a data sensor facility, and the like. The information infrastructure may include data repositories (e.g., business applications, databases, and data warehouses), virtualization systems, and cloud resources and services including virtual services, and the like. The business infrastructure may include business intelligence (BI) systems and analytics tools systems such as big data, artificial intelligence (AI), machine learning (ML), and the like.

The plurality of host systems 502A, 502B, . . . , 502 #, 512A, 512B, 522A can be understood as computing devices such as personal computers and workstations. For example, a first host system (H1) 502A can include a host processor (CPU) 104, and a host memory 106 described in FIG. 1. The host processor (CPU) 104 can perform data processing operations in response to user's needs, temporarily store data used or generated in the process of performing the data processing operations in the host memory 106 as an internal volatile memory, or transfer and store the data in the plurality of logical devices 510A, 510B, . . . , 510 #, 520A, 520B as needed.

When a user performs tasks that require many high speed operations, such as calculations or operations related to artificial intelligence (AI), machine learning (ML), and big data, resources such as a host memory 106 included in the first host system 502A might not be sufficient. The plurality of logical devices 510A, 510B, . . . , 510 #, 520A, 520B coupled to the first host system 502A can be used to overcome a limitation of internal resources such as the host memory 106.

Referring to FIG. 15, the connection device 550 can couple the plurality of host systems 502A, 502B, . . . , 502 #, 512A, 512B, 522A and the plurality of logical devices 510A, 510B, . . . , 510 #, 520A, 520B to each other. According to an embodiment, some of host processors could constitute a single system. In another embodiment, each host processor could be included in a distinct and different system. Further, according to an embodiment, some of logical devices could constitute a single shared memory device. In another embodiment, each logical device could be included in a distinct and different shared memory device.

A data storage area included in the plurality of logical devices 510A, 510B, . . . , 510 #, 520A, 520B can be exclusively assigned or allocated to the plurality of host systems 502A, 502B, . . . , 502 #, 512A, 512B, 522A. For example, the entire storage space of the storage LD1 of first logical device 510A may be exclusively allocated to and used by the first host system 502A. That is, another host system might not access the storage LD1 in first logical device 510A while the storage LD1 is allocated to the first host system 502A. A partial storage space in the storage LD2 of second logical device 510B may be allocated to the first host system 502A, while another portion therein may be allocated to the third host system 502C. In addition, a partial storage space in the storage LD2 of second logical device 510B might not be used by another host system except for the storage LD2 of second logical device. The storage LD3 of third logical device 510C may be allocated to, and used by, the second host system 502B and the third host system 512A. The storage LD4 of fourth logical device 510D may be allocated to, and used by, the first host system 502A, the second host system 502B, and the third host system 512A.

In the plurality of logical devices 510A, 510B, . . . , 510 #, 520A, 520B, unallocated storage spaces can be further allocated to the plurality of host systems 502A, 502B, . . . , 502 #, 512A, 512B, 522A based on a request from the plurality of host systems 502A, 502B, . . . , 502 #, 512A, 512B, 522A. Further, the plurality of host systems 502A, 502B, . . . , 502 #, 512A, 512B, 522A can request deallocation or release of the previously allocated storage space. In response to the request from the plurality of host systems 502A, 502B, . . . , 502 #, 512A, 512B, 522A, the connection device 550 can control connection or data communication between the plurality of host systems 502A, 502B, . . . , 502 #, 512A, 512B, 522A and the plurality of logical devices 510A, 510B, . . . , 510 #, 520A, 520B.

Referring to FIG. 15, the plurality of host systems 502A, 502B, . . . , 502 #, 512A, 512B, 522A may include the same component, but their internal components may be changed according to an embodiment. In addition, the plurality of logical devices 510A, 510B, . . . , 510 #, 520A, 520B may include the same component, but their internal components may be changed according to an embodiment.

According to an embodiment, the connection device 550 can be configured to utilize the plurality of logic devices 510A, 510B, . . . , 510 #, 520A, 520B to provide versatility and scalability of resources, so that the plurality of host systems 502A, 502B, . . . , 502 #, 512A, 512B, 522A can overcome limitations of internal resources. Herein, computer-memory link (e.g., Compute Express Link, CXL™) is a type of interface which utilizes different types of devices more efficiently in a high-performance computing system such as artificial intelligence (AI), machine learning (ML), and big data. For example, when the plurality of logical devices 510A, 510B, . . . , 510 #, 520A, 520B includes a CXL-based DRAM device, the plurality of host systems 502A, 502B, . . . , 502 #, 512A, 512B, 522A may expand memory capacity available for storing data.

If the connection device 550 provides cache consistency, there may be delays in allowing other processors to use variables or data updated by a specific processor in a process of sharing the variables or the data stored in a specific memory area. To reduce the delay in using the plurality of logical devices 510A, 510B, . . . , 510 #, 520A, 520B, a Compute Express Link-based (CXL-based) protocol or interface through the CXL-based switch 550A to 550C can assign a logical address range to memory areas in the plurality of logical devices 510A, 510B, . . . , 510 #, 520A, 520B. The logical address range is used by the plurality of host systems 502A, 502B, . . . , 502 #, 512A, 512B, 522A. Using a logical address in the logical address range, the plurality of host systems 502A, 502B, . . . , 502 #, 512A, 512B, 522A can access the memory areas allocated to the plurality of host systems 502A, 502B, . . . , 502 #, 512A, 512B, 522A. When each of the plurality of host systems 502A, 502B, . . . , 502 #, 512A, 512B, 522A requests a storage space for a specific logical address range, an available memory area included in the plurality of logical devices 510A, 510B, . . . , 510 #, 520A, 520B can be allocated for the specific logical address range. When each of the plurality of host systems 502A, 502B, . . . , 502 #, 512A, 512B, 522A requests a memory area based on different logical addresses or different logical address ranges, memory areas in the plurality of logical devices 510A, 510B, . . . , 510 #, 520A, 520B can be allocated for the different logical addresses or the different logical address ranges. If the plurality of host systems 502A, 502B, . . . , 502 #, 512A, 512B, 522A does not use a same logical address range, however, then a variable or data assigned to a specific logical address might not be shared by the plurality of host systems 502A, 502B, . . . , 502 #, 512A, 512B, 522A. Each of the plurality of host systems 502A, 502B, . . . , 502 #, 512A, 512B, 522A can use the plurality of logical devices 510A, 510B, . . . , 510 #, 520A, 520B as a memory expander to overcome limitations of their internal resources.

According to an embodiment, the plurality of logic devices 510A, 510B, . . . , 510 #, 520A, 520B may include a controller and a plurality of memories. The controller could be connected to the connection device 550 and control the plurality of memories. The controller can perform data communication with the connection device 550 through a Compute Express Link-based (CXL-based) interface. Further, the controller can perform data communication through a protocol and an interface supported by the plurality of memories. According to an embodiment, the controller can distribute data input/output operations transmitted to a shared memory device and manage power supplied to the plurality of memories in the shared memory device. Depending on an embodiment, the plurality of memories can include a dual in-line memory module (DIMM), a memory add-in card (AIC), and a non-volatile memory device supporting various connections (e.g., EDSFF 1U Long (E1 L.), EDSFF 1U Short (E1 S.), EDSFF 3U Long (E3U Long), EDSF (E3U Short), etc.).

The memory areas included in the plurality of logical devices 510A, 510B, . . . , 510 #, 520A, 520B may be allocated for, or assigned to, the plurality of host systems 502A, 502B, . . . , 502 #, 512A, 512B, 522A. A size of memory area allocated for, or assigned to, the plurality of host systems 502A, 502B, . . . , 502 #, 512A, 512B, 522A can be changed or modified in response to a request from the plurality of host systems 502A, 502B, . . . , 502 #, 512A, 512B, 522A. In FIG. 15, it is shown that the plurality of host systems 502A, 502B, . . . , 502 #, 512A, 512B, 522A is coupled to the plurality of logic devices 510A, 510B, . . . , 510 #, 520A, 520B through the connection device 550. However, according to an embodiment, the storage areas included in the plurality of logical devices 510A, 510B, . . . , 510 #, 520A, 520B may also be allocated for, or assigned to, a virtual machine (VM) or a container. Herein, a container is a type of lightweight package that includes application codes and dependencies such as programming language runtimes and libraries of a specific version required to run software services. The container could virtualize the operation system. The container can run anywhere from a private data center to a public cloud or even on a developer's personal laptop.

According to an embodiment, to improve or enhance data I/O performance of the data infrastructure, at least one host and at least one logical device or memory system can perform data communication through a CXL-based interface or CXL-based protocol that supports memory pooling and memory sharing. The memory pooling can allow multiple hosts of a heterogeneous topology to access a common memory address range, and each host can be assigned a non-overlapping address range from a pool of memory resources. Through the memory pooling, a data infrastructure or a data processing apparatus can dynamically allocate a storage area or a memory area within the pool, thereby reducing wasted memory and increasing memory utilization. The CXL-based interface or CXL-based protocol can provide effects such as efficient memory allocation, guaranteed memory access, memory isolation between multiple hosts or processors, and data or system security.

Further, the memory sharing can allow multiple hosts of a heterogeneous topology to access a common memory address range, and each host and other hosts may be assigned the same address range. Because multiple hosts can access the same data, data flow can be efficient, but the data infrastructure or data processing apparatus can manage coherency between the hosts to avoid data from being incorrectly overwritten by other hosts. The CXL-based interface or CXL-based protocol can provide effects such as efficient data communication, low latency, and reduced power consumption between multiple hosts or processors.

According to an embodiment, the plurality of host systems 502A, 502B, . . . , 502 #, 512A, 512B, 522A can send raw commands to the plurality of logical devices 510A, 510B, . . . , 510 #, 520A, 520B. A raw command can send a command or code (opcode) specified by user space to the underlying hardware and bypass all driver checks for the command. The raw command is one of the commands supported by the CXL-based protocol or interface or promised by vendors. The raw command can enable direct control of a specific hardware device. For example, tasks such as memory access or data read/write can be performed through raw commands. The raw command can be transmitted through a mailbox included in a memory system or a memory controller coupled to a plurality of memory devices.

FIG. 16 illustrates a Compute Express Link-based (CXL-based) switch 120 according to an embodiment of the present disclosure. The CXL-based switch 120 described in FIG. 16 can correspond to at least one CXL-based switch 550A, 550B, 550C included in the connection device 550 described in FIG. 15.

Referring to FIG. 16, a plurality of root ports 108A, 108B and a plurality of logic devices 110A, 110B, 110C, 110D may be coupled through the CXL-based switch 120.

According to an embodiment, the plurality of root ports 108A, 108B may be included in a root complex located between the plurality of logical devices 110A, 110B, 110C, 110D supporting a Compute Express Link-based (CXL-based) interface and the plurality of host systems 502A, 502B, . . . , 502 #, 512A, 512B, 522A in FIG. 15 or the host CPU shown in FIG. 1. The root complex is an interface located between the plurality of host systems 502A, 502B and a connection component such as a PCIe Bus. The root complex may include several components, several chips, system software, and the like, such as a processor interface, a DRAM interface, and the like. The root complex can logically combine hierarchical domains such as PCIe into a single hierarchy. Each fabric instance may include a plurality of logical devices, switches, bridges, and the like. The root complex can calculate a size of a storage space in each logical device and map the storage space to an operating system, to generate an address range table. According to an embodiment, the plurality of host systems 502A, 502B may be connected to different root ports 108A, 108B respectively to configure different host systems.

The root ports 108A, 108B may refer to a PCIe port included in the root complex that forms a part of PCIe interconnection hierarchy through a virtual PCI-PCI bridge which is coupled to the root ports 108A, 108B. Each of the root ports 108A, 108B may have a separate hierarchical area. Each hierarchical area may include one endpoint, or sub-hierarchies including one or more switches or a plurality of endpoints. Herein, an endpoint may refer to one end of the communication channel. The endpoint may be determined according to circumstances. For example, in a case of physical data communication, an endpoint may refer to a server or a terminal, which is the last device connected through a data path. In terms of services, an endpoint may indicate an Internet identifier (e.g., uniform resource identifiers, URIs) corresponding to one end of the communication channel used when using a service. An endpoint may also be an Internet identifier (URIs) that enables an Application Programming Interface (API), which is a set of protocols that allow two systems (e.g., applications) to interact or communicate with each other, to access resources on a server.

The CXL-based switch 120 is a device that can attach the plurality of logical devices 110A, 110B, 110C, 110D, which are multiple devices, to one root port 108A or 108B. The CXL-based switch 120 can operate like a packet router and recognize which path a packet should go through based on routing information different from an address of the packet. Referring to FIG. 16, the CXL-based switch 120 can include a plurality of bridges.

Computer-memory link (e.g., Compute Express Link, CXL™) is a dynamic multi-protocol technology designed to support accelerators and memory devices. CXL™ can provide a set of protocols including protocols (e.g., CXL.io) that include PCIe-like I/O semantics, protocols (e.g., CXL.cache) that include caching protocol semantics, and protocols including memory access semantics over individual or on-package (on-package) links. Semantics may refer to prediction and ascertainment of what will happen and what the outcome will be to the meaning given by units such as expressions, sentences, and program codes when a program or an application, which is configured of a language which is a type of communication system governed by sentence generation rules in which elements are combined in various ways. For example, a first CXL-based protocol (CXL.io) can be used for search and enumeration, error reporting, and Host Physical Address (HPA) inquiry. A second CXL-based protocol (CXL.mem) and a third CXL-based protocol (CXL.cache) may be selectively implemented and used by a specific accelerator or a memory device usage model. The CXL-based interface can provide low-latency, high-bandwidth paths for an accelerator to access a system or for a system to access a memory connected to a CXL-based device (e.g., a memory system).

The Compute Express Link-based (CXL-based) switch 120 is an interconnect device for connecting the plurality of root ports 108A, 108B and the plurality of logical devices 110A, 110B, 110C, 110D supporting CXL-based data communication. For example, the plurality of logical devices 110A, 110B, 110C, 110D may refer to a PCIe-based device or a logical device LD. PCIe (i.e., Peripheral Component Interconnect Express) refers to a protocol or an interface for connecting a computing device and a peripheral device. Using a slot or a specific cable to connect a host such as a computing device to a memory system such as a peripheral device connected to the computing device, PCIe can have a bandwidth over several hundreds of MBs per second (e.g., 250 MB/s, 500 MB/s, 984.6250 MB/s, 1969 MB/s, etc.) by using a plurality of pins (e.g., 18, 32, 49, 82, etc.) and at least one wire (e.g., ×1, ×4, ×8, ×16). Using CXL-based switching and pooling, the plurality of host processors and the plurality of logical devices can be connected through the CXL-based switch 120, and all or a part of each logical device connected to the CXL-based switch 120 can be assigned as a logical device to several host processors. A logical device LD is an entity that refers to a CXL-based endpoint bound to a virtual CXL-based switch (VCS).

According to an embodiment, the logical device LD may include a single logical device (Single LD) or a multi-logical device (MLD). The plurality of logical devices 110A, 110B, 110C, 110D that support the Compute Express Link-based (CXL-based) interface could be partitioned into up to 16 distinguished logical devices like a memory managed by the host. Each logical device can be identified by a logical device identifier LD-ID used in the first CXL-based protocol (CXL.io) and the second CXL-based protocol (CXL.mem). Each logical device can be identified in the virtual hierarchy (VH). A control logic or circuit included in each of the plurality of logical devices 110A, 110B, 110C, 110D may control and manage a common transaction and link layer for each protocol. For example, the control logic or circuit in the plurality of logical devices 110A, 110B, 110C, 110D can access various architectural functions, control, and status registers through an Application Programming Interface (API) provided by a fabric manager 130, so that the logic device LD can be configured statically or dynamically.

Referring to FIG. 16, the CXL-based switch 120 can include a plurality of virtual CXL-based switches 122, 124. The virtual CXL-based switch (VCS) 122, 124 may include entities within a physical switch belonging to a single virtual hierarchy (VH). Each entity may be identified using a virtual CXL-based switch identifier VCS-ID. The virtual hierarchy (VH) may include a rendezvous point (RP), a PCI-to-PCI bridge (PPB) 126, and an endpoint. The virtual hierarchy (VH) may include everything arranged under the rendezvous point (RP). The structure of the CXL-based virtual layer may be similar to that of PCIe. A port connected to a virtual PCI-PCI bridge (vPPB) and a PCI-PCI bridge (PPB) inside the CXL-based switch 120 controlled by the fabric manager (FM) 130 can provide or block connectivity in response to various protocols (PCIe, CXL™ 1.1, CXL™ 2.0 SLD, CXL™ 2.0 MLD, or CXL™ 3.0 MLD). The fabric manager (FM) 130 can control an aspect of the system related to binding and management of pooled ports and devices. The fabric manager (FM) 130 can be considered a separate entity distinguished from a switch or host firmware. In addition, virtual PCI-PCI bridges (vPPBs) and PCI-PCI bridges (PPBs) controlled by the fabric manager (FM) 130 can provide data links including traffic from multiple virtual CXL-based switches (VCS) or unbound physical ports. Messages or signals by the fabric manager (FM) 130 can be delivered to a fabric manager (FM) endpoint 128 in the CXL-based switch 120, and the CXL-based switch 120 can control multiple switches or bridges included therein based on the message or signal delivered to the fabric manager endpoint 128.

According to an embodiment, the CXL-based switch 120 can include a PCI-PCI bridge (PPB) 126 corresponding to each of the plurality of logical devices 110A, 110B, 110C, 110D. The plurality of logical devices 110A, 110B, 110C, 110D may have a 1:1 corresponding relationship with the PCI-PCI bridge PPB 126. In addition, the CXL-based switch 120 can include a virtual PCI-PCI bridge (vPPB) corresponding to each of the plurality of root ports 108A, 108B. The plurality of root ports 108A, 108B and the plurality of virtual PCI-PCI bridges vPPB 122, 124 may have a 1:1 corresponding relationship. The CXL-based switch 120 may have a different configuration corresponding to the number of the plurality of root ports 108A, 108B and the number of the plurality of logical devices 110A, 110B, 110C, 110D.

Referring to FIG. 16, the fabric manager (FM) 130 may connect one virtual PCI-PCI bridge (vPPB) among the second virtual CXL-based switches 122 with one PCI-PCI bridge (PPB) among PCI-PCI bridges (PPBs) 126 and unbind other virtual PCI-PCI bridges (vPPB) included in the first CXL-based switches 122 and the second virtual CXL switches 124 to any PCI-PCI bridge (PPB) among PCI-PCI bridges (PPBs) 126. That is, connectivity between the first CXL switches 122, or the second virtual CXL-based switches 124, and the PCI-PCI bridges (PPBs) 126 may be achieved selectively. Like this configuration, the CXL-based switch 120 can perform a function of connecting a virtual layer to a physical layer (Virtual to Physical Binding).

Referring to FIGS. 15 and 16, the storage space (e.g., memory areas) in the plurality of logical devices 110A, 110B, 110C, 110D may be shared by the plurality of host systems 502A, 502B, . . . , 502 #, 512A, 512B, 522A. For example, the storage space of the first logical device storage LD1 may be configured to store data corresponding to a logical address range of 1 to 100, and the storage space of the second logical device storage LD2 may be configured to store data corresponding to another logical address range of 101 to 200. The plurality of logical devices 110A, 110B, 110C, 110D can be accessed through logical addresses of 1 to 400. Further, the plurality of host systems 502A, 502B, . . . , 502 #, 512A, 512B, 522A can share access information regarding which host processor uses or accesses the storage space in the plurality of logical devices 110A, 110B, 110C, 110D based on the logical addresses of 1 to 400. For example, logical addresses of 1 to 50 may be assigned to, and allocated for, the first host system 502A, and other logical addresses of 51 to 100 may be assigned to, and allocated for, the second host system 502B. In addition, other logical addresses of 101 to 200 may be assigned to, and allocated for, the first host system 502A.

A range of logical addresses assigned to each logical device in the plurality of logical devices 110A, 110B, 110C, 110D can be different in response to a size of the storage space of the logical device included in the shared memory device. In addition, a storage space that has been allocated to the plurality of host systems 502A, 502B, . . . , 502 #, 512A, 512B, 522A may be released in response to a release request of the plurality of host systems 502A, 502B, . . . , 502 #, 512A, 512B, 522A.

As above described, according to an embodiment of the present disclosure, a data processing apparatus can reduce a response time for a read request input from a host based on an operation performed within a Compute Express Link-based (CXL-based) device in response to a speculative read request among requests input from the host.

In addition, according to an embodiment of the present disclosure, a host in a data processing device can transmit to a memory system a speculative read request along with residual time information for temporarily storing data corresponding to the speculative read request in a buffer, and the memory system can maintain speculatively read data in the buffer during the residual time in response to the speculative read request, thereby enhancing the effect of reducing an access latency even though the memory system has limited sources.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods or operations of the computer, processor, controller, or other signal processing device, are described in detail, the code or instructions for implementing the operations of the method embodiments may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, generators, logic, interfaces, decoders, drivers, and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, generators, logic, interfaces, decoders, drivers, and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, generators, logic, interfaces, decoders, drivers, and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods or operations of the computer, processor, microprocessor, controller, or other signal processing device, are described in detail, the code or instructions for implementing the operations of the method embodiments may transform the computer, processor, controller, or other signal processing device into a special-purpose processor for performing the methods described herein.

While the present teachings have been illustrated and described with respect to the specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A memory system coupled to at least one memory device and comprising a processor and a memory coupled to the processor, the memory storing program instructions that, when executed by the processor, cause the processor to:
receive data output from the memory device based on a speculative read request input from a host;
store the received data in a read buffer based on information about a residual time input along with the speculative read request; and
output first data among the data stored in the read buffer to the host, the first data which is stored in the read buffer based on the speculative read request and linked to a read request input from the host after the speculative read request.

2. The memory system according to claim 1, wherein the read buffer is configured to temporarily store data which is read and output from the at least one memory device based on the speculative read request and the read request.

3. The memory system according to claim 2, wherein the read buffer is configured to:
store second data which is read from the memory device based on the speculative read request but not linked to the read request input from the host;
release the second data based on the residual time after stored in the read buffer; and
store third data which is read from the memory device based on the read request and input to and output from the read buffer by a first in first out (FIFO) way.

4. The memory system according to claim 1, comprising a hazard control unit configured to:
perform a control hazard operation that transmits or schedules a read command to the memory device based on the speculative read request or the read request, and
perform a data hazard operation that receives at least one data corresponding to the read command from the memory device and manages the at least one data to be output to the host.

5. The memory system according to claim 4, wherein the hazard control unit comprises:
a flow controller configured to determine a processing order of the speculative read request and the read request;
a decoder configured to identify a target of the speculative read request or the read request;
the read buffer configured to temporarily store the at least one data which is read and output from the memory device based on the speculative read request or the read request;
an arbiter configured to transmit a control signal corresponding to the speculative read request or the read request to the memory device; and
a response generator configured to generate a response corresponding to the read request based on the at least one data stored in the read buffer.

6. The memory system according to claim 5, wherein the hazard control unit further comprises a read pointer controller configured to verify whether a target of the read request transmitted from the flow controller is stored in the read buffer by the speculative read request before a read operation corresponding to the read request.

7. The memory system according to claim 5, wherein the decoder is configured to, based on a verification result of the read pointer controller, perform one of:
transferring the read request to the arbiter; and
notifying the response generator whether the target of the read request exists in the read buffer.

8. The memory system according to claim 5, wherein the at least one data stored in the read buffer comprises at least one of:
second data which is read from the memory device based on the speculative read request but not linked to the read request input from the host;
release the second data based on the residual time after stored in the read buffer; and
third data which is read from the memory device based on the read request and released when the response corresponding to the read request is generated.

9. The memory system according to claim 1, wherein the information about the residual time comprises at least one of:
a first value indicating the residual time; and
a second value indicating an increase or decrease from a reference value which is set by the host.

10. A memory system comprising:
at least one processor; and
at least one memory device coupled to the processor via a data path,
wherein the processor is configured to:
transfer a speculative read request to the memory device;
receive data output from the memory device based on the speculative read request;
store the received data in a read buffer based on information about a residual time input along with the speculative read request; and
output first data among the data stored in the read buffer to the host, the first data which is stored in the read buffer based on the speculative read request and linked to a read request input from a host after the speculative read request.

11. The memory system according to claim 10, wherein the speculative read request comprises at least one of:
a first value indicating the residual time; and
a second value indicating an increase or decrease from a reference value which is set by the host.

12. The memory system according to claim 10, wherein the read buffer is configured to temporarily store data which is read and output from the at least one memory device based on the speculative read request and the read request.

13. The memory system according to claim 12, wherein the read buffer is configured to:
store second data, read from the memory device based on the speculative read request but not linked to the read request input from the host;
release the second data based on the residual time after stored in the read buffer; and
store third data which is read from the memory device based on the read request and input to and output from the read buffer by a first in first out (FIFO) way.

14. The memory system according to claim 10, comprising a hazard control unit configured to:
perform a control hazard operation that transmits or schedules a read command to the memory device based on the speculative read request or the read request, and
perform a data hazard operation that receives at least one data corresponding to the read command from the memory device and manages the at least one data to be output to the host.

15. The memory system according to claim 14, wherein the hazard control unit comprises:
a flow controller configured to determine a processing order of the speculative read request and the read request;
a decoder configured to identify a target of the speculative read request or the read request;
the read buffer configured to temporarily store the at least one data which is read and output from the memory device based on the speculative read request or the read request;
an arbiter configured to transmit a control signal corresponding to the speculative read request or the read request to the memory device; and
a response generator configured to generate a response corresponding to the read request based on the at least one data stored in the read buffer.

16. The memory system according to claim 15, wherein the hazard control unit further comprises a read pointer controller configured to verify whether a target of the read request transmitted from the flow controller is stored in the read buffer by the speculative read request before a read operation corresponding to the read request.

17. The memory system according to claim 15, wherein the decoder is configured to, based on a verification result of the read pointer controller, perform one of:
transferring the read request to the arbiter; and
notifying the response generator whether the target of the read request exists in the read buffer.

18. The memory system according to claim 15, wherein the at least one data stored in the read buffer comprises at least one of:
second data which is read from the memory device based on the speculative read request, but not linked to the read request input from the host, and released based on the residual time after stored in the read buffer; and
third data which is read from the memory device based on the read request and released when the response corresponding to the read request is generated.

19. A data processing apparatus comprising:
at least one host configured to transmit a speculative read request along with information about a residual time through a computer-memory link-based protocol or interface and transmit a read request after transmitting the speculative read request; and
a memory system configured to store first data corresponding to the speculative read request in a read buffer during the residual time, find second data corresponding to the read request among the first data stored in the read buffer, and output the second data to the host.

20. The data processing apparatus according to claim 19, wherein the memory system is configured to:
when the second data is stored in the read buffer after a read operation performed by the memory device in response to the read request, generate a response including the second data and then remove the second data from the read buffer, and
wherein the first data corresponding to the speculative read request is removed from the read buffer based on the residual time.
